(19) United States
(12) Patent Application Publication
(10) Pub. No.: US 2002/0076262 A1
(43) Pub. Date: Jun. 20, 2002

(54) Ring binder housing cover

(76) Inventor: Chun-Yuen To, Hong Kong (CN)

Correspondence Address: CHITTARANJAN N. NIRMEL, NIRMEL & ASSOCIATES, SUITE 304, 1730 K ST., N.W., WASHINGTON, DC, 20006, US

(21) Appl. No.: 09/984,521

(22) Filed: Oct. 30, 2001

Related U.S. Application Data
(63) Continuation-in-part of application No. 09/698,075, filed on Oct. 30, 2000.
(60) Provisional application No. 60/292,266, filed on May 21, 2001.

(51) Int. Cl. B42F 13/00

(52) U.S. Cl. 402/73

(57) ABSTRACT

A thin flexible cover is fitted over the item-retaining housing in a conventional ring binder. The cover may be adhered, snap-fitted, or permanently attached, e.g., by riveting, to the underlying housing portion. A visible surface of the cover is provided with information relating to items to be retained in the ring binder by symbols, letters, numerals or the like in different colors, textures or even in Braille to meet the needs of a sight-impaired user. The item-related information thus provided is accessible to the user when the ring binder is in its open stste and contains retained items on one or both sides of the central housing. By suitable choice of thickness and stiffness of the cover material, the cover can be used to enhance the item-retaining function of the ring binder. The cover, in all of its embodiments, also serves to protect retained items from damage due to scratching, denting, or rusting/corrosion of metal elements of the item-retaining housing over time. In various aspects, the cover may be applied to the housing either permanently or removably, either when the ring binder is manufactured or subsequently.

This is a Continuation-in-Part claiming priority to copending U.S. patent application Ser. No. 09/698,075 of Chun Yuen TO, titled “Ring Binder Housing Cover”, filed on Oct. 30, 2000, and to copending Provisional Patent Application Ser. No. 60/292,266 of Chun Yuen TO also titled “Ring Binder Housing Cover”, filed on May 21, 2001.

### FIELD OF THE INVENTION

This invention relates to a cover element to be disposed over an item-retaining housing portion of a cover element to be disposed over an item-retaining portion of a conventional ring binder. More specifically, the invention relates to a cover element to be attached to a visible portion of an item-retaining housing element in a conventional ring binder to selectively provide visible or tactile information about its contents, augment its item-retaining function, protect the contents against corrosion-related damage, and protect a user against certain metal-allergy contact reactions.

### BACKGROUND OF THE RELATED ART

Conventional ring binders, like the one illustrated in FIG. 1, are used for retention of items such as papers, booklets, photograph-holder sleeves, flat samples, and the like. Typically, such a ring binder 100 comprises a pair of generally similar side elements 102a and 102b pivotably attached on opposite parallel sides of a central backing element 104. The pivoting attachment of elements 102a, 102b to backing element 104 may be realized by narrow gauge hinges or by the use of innately flexible materials such as vinyl, fabric or leather. In such a conventional ring biner, mounted to an inside surface of central element 104, is an item-retaining housing element 106 generally made of steel.

Most users employ ring binders with distinctively colored outsides, thereby at a glance learning something about the contents. For example, in a lawyer's office it may be convenient to retain documents pertaining to a plaintiff's case in ring binders of a first color and corresponding documents relating to a defendant's case in ring binders of a second color. Also, it is conventional to apply labels bearing information relating to the contents of individual binders either on an outer surface of central element 104 or on an outer surface of the left-element such as 102a.

However, once a ring binder is in use in an open state, often fairly full of items retained therein, it is inconvenient for a user to view an external label to determine just what kind of items are retained in the ring binder. This problem is aggravated when there are numerous ring binders in continuous use by a number of people who may have a common mission but who may also have to periodically remove and replace individual items in different ring binders, e.g., as may happen during the course of an active and complex litigation where legal staff are handling many documents and numerous ring binders.

It would therefore be highly desirable if a user of an open ring binder, especially one that contains numerous items, were able to determine at a glance (or at a touch if blind) useful information concerning items retained in the ring binder. The present invention is intended to solve this problem simply, inexpensively, and in a manner that permits use by sighted people and by blind users.

Another problem that is often encountered in the use of conventional ring binders is that after prolonged use, during which items are removed and replaced frequently, the springiness of the retaining mechanism is lost. When this happens, a user who hurriedly grabs a ring binder may find that the item-retaining elements suddenly release numerous items due to inertial or gravitational forces. This can result in the user's embarrassment and may incur a waste of time in replacement of the items in their correct order within the ring binder. The present invention, in one of its embodiments, addresses this problem also.

Even further, experience shows that when ring binders are stored for prolonged periods in storage facilities where there is low air circulation, changes in ambient temperature and humidity in time may cause the steel item-retaining elements of the ring binder to rust. Sometimes, the non-metallic components of the ring binder cover may release gases or vapors that may corrode metallic components. This can damage items contained in the ring binder and may also make subsequent use of the item-retaining elements difficult. The present invention offers a solution to this problem as well.

### SUMMARY OF THE INVENTION

It is a principal object of this invention to provide a user of a conventional ring binder readily perceptible information concerning the contents of the ring binder.

Another principal object of the invention is to provide a cover element that fits to the typical item-retaining housing found in conventional ring binders, so as to readily provide a user of the ring binder information concerning items being retained in the ring binder and simultaneously increasing a bias force on elements that retain items in the ring binder.

Yet another object of this invention is to provide a cover element that is easily attachable to the central item-retaining housing portion of a conventional ring binder which serves to provide readily perceptible information concerning items retained in the ring binder and to provide protection against corrosion resulting from ambient moisture or chemicals present in material used in portions of the ring binder other than the metal housing.

A related object of the invention is to provide a method by which a user of a conventional ring binder can readily determine a selected aspect of items retained in the ring binder.

A related further object of the invention is to provide a method by which the user of a conventional ring binder can selectively increase the stiffness of an element retaining items in the ring binder.

Accordingly, in a first aspect of this invention there is provided an information-conveying cover for a longitudinal item-retaining housing that includes retaining elements for retaining items in a ring binder. The cover has an elongate body portion which is formed to fit to and cover a selected portion of the housing. The cover is also provided with a retaining mechanism for retaining it to the housing so that a first surface of the elongate body portion is readily perceptible by a user regardless of items retained on either side of the housing while the ring binder in an open state.

In another aspect of the invention, there is provided a method which enables a user to readily ascertain a selected aspect of items retained by retainer elements of an item-retaining housing in a ring binder. The method includes the step of attaching to the housing a cover element which has a first surface perceptible by a user independently of any items retained in the ring binder during use; and a further step of providing information at the first surface which relates to a selected aspect of the retained items.

In yet another aspect of the invention, there is provided an improved ring binder for retaining items therein, the ring binder comprising an outer binder body, an item holder body element which is attached to an inside of the binder body and has at least one forcibly biased item-retaining element, and a cover that is attachable to the item holder body and bears readily-perceptible information related to items to be retained in the ring binder.

These and other related aspects and benefits of the disclosed invention and its obvious variations will be better understood from the detailed description provided below with appropriate reference to the appended drawing figures and claims.

### BRIEF DESCRIPTION OF THE DRAWINGS

FIG. 1 is a perspective view of a conventional ring binder in an open and empty state.

FIG. 2 is a perspective view of a conventional ring binder that includes a first embodiment of the invention and is in an open and empty state.

FIGS. 3(A) and 3(B) are perspective views of the central item-retaining housing portion of a conventional ring binder, inclusive of the first embodiment of the present invention, in the closed and open states respectively.

FIGS. 4(A) and 4(B) are perspective views of the housing per FIGS. 3(A) and 3(B) from an opposite side.

FIG. 5 is an exploded view of the components of the item-retaining housing portion of a conventional ring binder together with the first embodiment of the present invention.

FIGS. 6(A), 6(B) and 6(C) are, respectively, a side view, an enlarged view of an end ring portion, and a side view of a central ring portion of a conventional ring binder housing together with the first embodiment of the present invention.

FIGS. 7(A) and 7(B) are transverse cross-sectional views, at section VII-VII in FIGS. 3(A) and 3(B).

FIGS. 8(A) and 8(B) are perspective views of the central item-retaining housing portion of a conventional ring binder, inclusive of the second embodiment of this invention, in the open and closed states respectively.

FIGS. 9(A) and 9(B) are perspective views of the housing per FIGS. 8(A) and 8(B) from an opposite side.

FIG. 10 is an exploded view of the components of an item-retaining housing portion of a conventional ring binder together with the second embodiment of this invention.

FIGS. 11(A) and 11(B) are a side view and an enlarged view, respectively, of the item-retaining portion of a conventional ring binder together with the second embodiment of this invention.

FIGS. 12(A) and 12(B) are transverse cross-sectional views, at sections XIIA-XIIA and XIIB-XIIB in FIGS. 8(A) and 8(B) respectively.

FIG. 13(A) is a transverse cross-sectional view of a cover according to the second embodiment of the present invention; FIG. 13(B) is a transverse cross-sectional view of principal elements of an item-retaining housing portion of a conventional ring binder; and FIG. 13(C) is a transverse cross-sectional view of the second embodiment of the invention in place and closely fitted to the principal element according to FIG. 13(B).

FIG. 14(A) is a transverse cross-sectional view, at section XIIA-XIIA in FIG. 8(A), with a third embodiment of this invention securely attached to a principal element of the item-retaining portion of a conventional ring binder; and FIG. 14(B) is an enlarged view to illustrate particular details of FIG. 14(A).

FIGS. 15(A) and 15(B) are perspective views of a fourth embodiment of the present invention in position for use as fitted to element 108 of a conventional ring binder housing.

FIGS. 16(A) and 16(B) provide opposite views to clarify certain structural details which differ from those of corresponding elements in the previously discussed embodiments.

FIG. 17 is an exploded view of an item-retaining housing of a conventional ring binder with the fourth embodiment of this invention.

FIGS. 18(A) and 18(B) are a side view and an enlarged view, respectively, of the item-retaining portion of a conventional ring binder with the fourth embodiment of this invention.

FIG. 19 is a transverse cross-sectional view, at Section XIX-XIX in FIG. 15(A).

FIGS. 20(A) and 20(B) are transverse cross-sectional views, at sections XX-XX in FIGS. 15(A) and 15(B), respectively.

FIGS. 21(A) and 21(B) and 21(C) are different perspective views to clarify certain structural aspects of the fourth embodiment.

FIGS. 22(A) and 22(B) are additional perspective views of the fourth embodiment.

FIG. 23 is a perspective view of a fifth embodiment of this invention as fitted to a ring binder housing in operational position.

FIGS. 24(A) and 24(B) are perspective views of a sixth embodiment of this invention as fitted to a ring binder housing in operational position, and FIGS. 25(A) and 25(B) are opposite views of the same.

FIG. 26 is an exploded view of the principal elements; FIGS. 27(A) and 27(B) are side views; and FIGS. 28(A) and 28(B) are cross-sectional views at Section XXIIIV-XXIIIV in FIG. 27(A), respectively.

FIGS. 29(A) and 29(B) are two perspective views of the cover per the sixth embodiment to illustrate certain details thereof

FIGS. 30(A) through 35(B) are similar views of the seventh embodiment.

FIGS. 36(A) through 42(B) are similar views of the eighth embodiment.

FIGS. 43(A) through 48 are comparable views of the ninth embodiment.

### DETAILED DESCRIPTION OF THE PREFERRED EMBODIMENTS

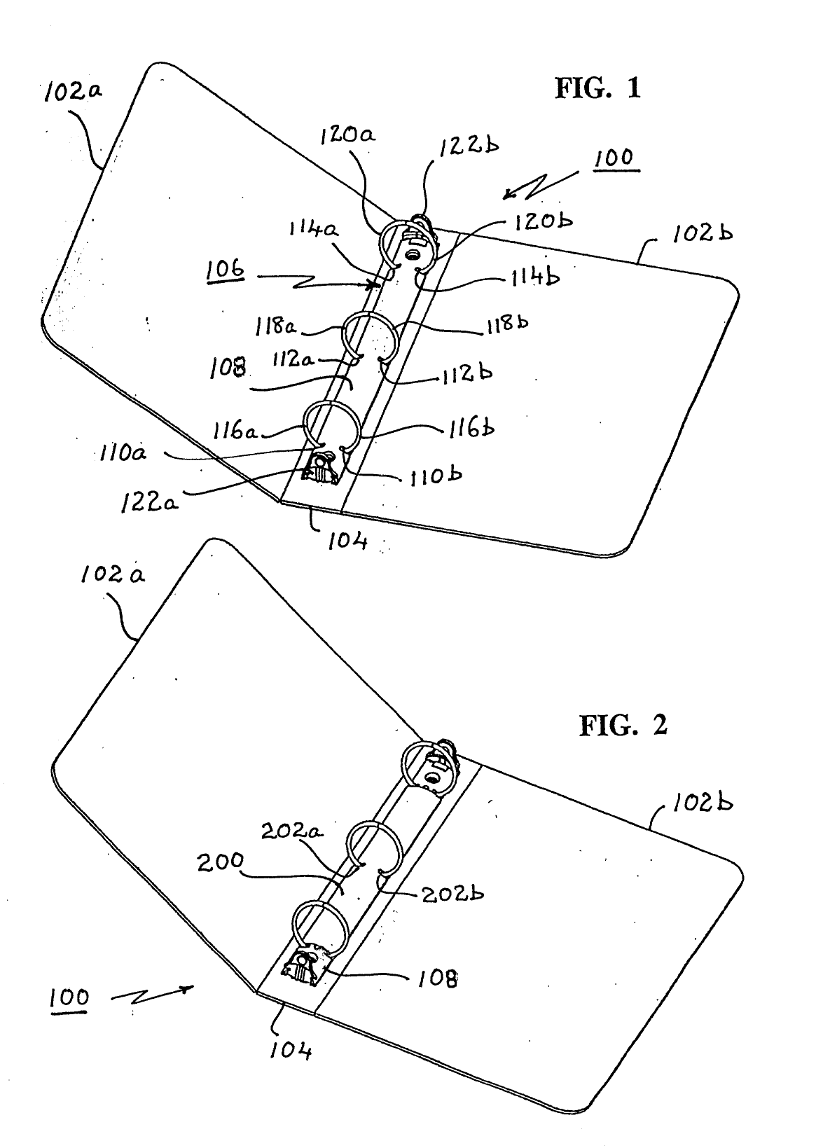

FIG. 1 shows, in perspective view, a conventional ring binder 100 that has a three-part cover portion in which two relatively large outer cover elements 102a, 102b are pivotably connected to a central element 104 which provides a base for secure attachment of an item-retaining housing 106.

Housing 106 has an elongate outer element 108, of curved profile, formed with three pairs of spaced-apart notches 110a, 110b, 112a, 112b, and 114a, 114b, which permit opening and closing movements of corresponding pairs of split rings 116a, 116b, 118a, 118b, and 120a, 120b, respectively. These item-retaining split rings are moveable from a closed to an open position and vice versa, by a force applied to either or both of levers 122a and 122b which are pivotally supported to opposite ends of element 108, as best seen in FIGS. 1 and 2. The split rings are normally kept in their closed positions by a bias force generated as described below.

FIG. 2 shows how a first embodiment of the present invention 200 is disposed in use relative to item-retaining housing 106 inside a conventional ring binder 100. Note that in this first embodiment the overall length of cover 200 is a little less than the spaced-apart distance between inside surfaces of split ring elements 116a, 116b and 120a, 120b. Note also that cover 200 is provided with a pair of transverse notches or cutouts 202a, 202b which are preferably slightly larger than and are positioned to overlap notches 112a, 112b, respectively, of housing element 108.

During use of embodiment 200, while the ring binder is in an open state and even when it contains retained items on one or both sides, the upper curved surface of cover 200 should be readily perceptible by the user. If cover 200 is made of a soft and compliant material it will assume the curvature of element 108, but if necessary can be made to have a matching profile. Any information contained on this surface, e.g., a single color or pattern of colors, letters or numerals, or combinations of colors, letters and numerals, coded to be related to some selected aspect of the items contained in that particular ring binder, thus become immediately available to the user. For example, a number of ring binders may be employed to contain litigation documents, and different ring binders may contain documents produced by the plaintiff (or plaintiffs) and the defendant (or defendants). Simple symbols may be employed on the visible surface of cover 200 to indicate which party's documents are in a particular binder, what kind of documents from that particular party are included, and which set or subset of a particular type of documents is contained in that particular ring binder. Thus, even if a large number of ring binders are opened up on a large work table, and a number of legal assistants are working cooperatively to process a large volume of documents contained in separate ring binders, each worker can at a glance determine exactly which ring binder contains a particular document that is desired. This should work even if all the items in the ring binder are on one side or the other and, likewise, when items are disposed some on each side of the ring binder. This conveyance of information visually should be equally effective when the split rings are in their open or closed states. Note that this does not require a user to pick up the ring binder and look at the outer surface where information about the contents of the ring binder is conventionally provided.

Cover 108 may be made from a variety of materials, e.g., paper, fabric, plastic, metal, composites, and various combinations of such materials. As a practical matter, paper may make it easiest to provide printed information in a variety of formats such as color, symbols, letters, and/or numerals of various sizes. Even information in the form of a bar code could be readily included. Virtually the same degree of freedom should be available with the use of plastic materials and plastic covered fabric. If thin metal is used to form cover 200, the visible surface, likewise, could be provided with a variety of colors, textures, and/or symbols.

Cover 200 preferably is made of a thin sheet of the selected material. On the surface opposite to the one that bears the desired information a thin coating of a known adherent may be provided and may be initially protected by a piece of wax paper or the like in known manner. To use it, a user would simply expose the adherent and position cover 200 over element 108 of the item-retaining housing, preferably with the split rings in their open state. After suitable alignment, cover 200 may simply be attached to element 108 by smooth even pressure. It can be removed, if necessary, and replaced with another cover as and when appropriate.

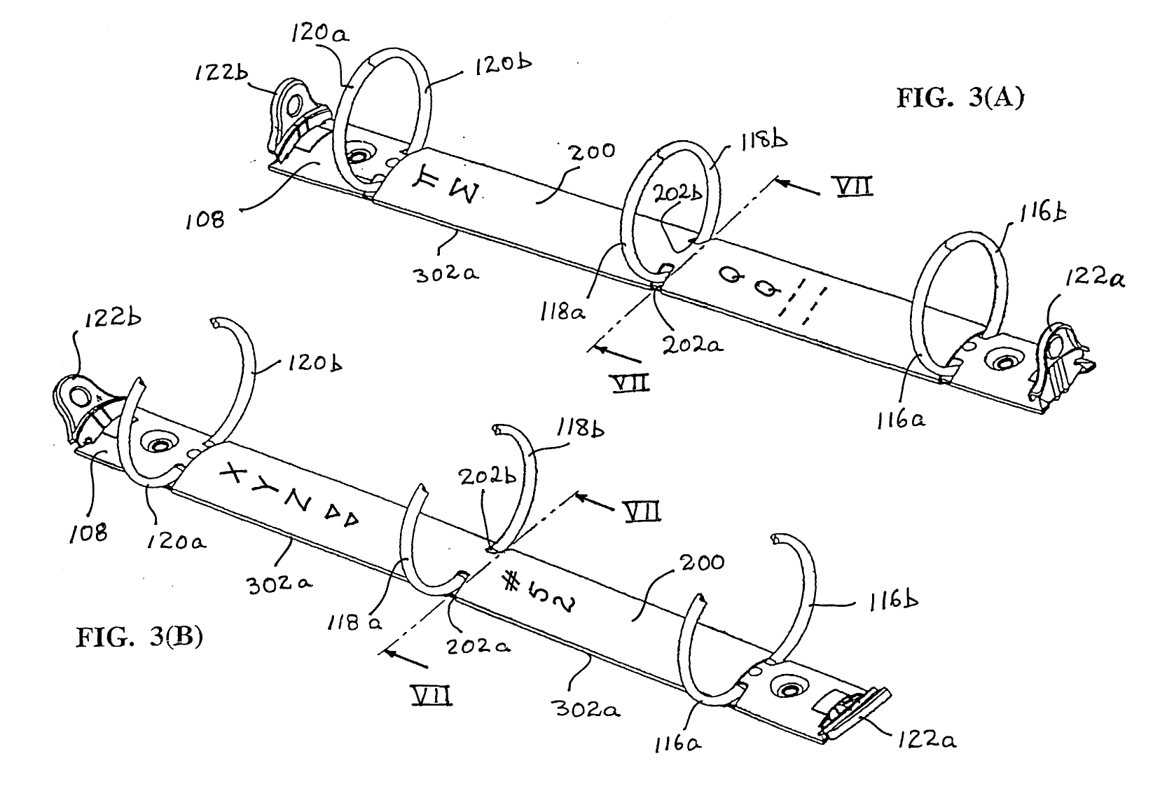

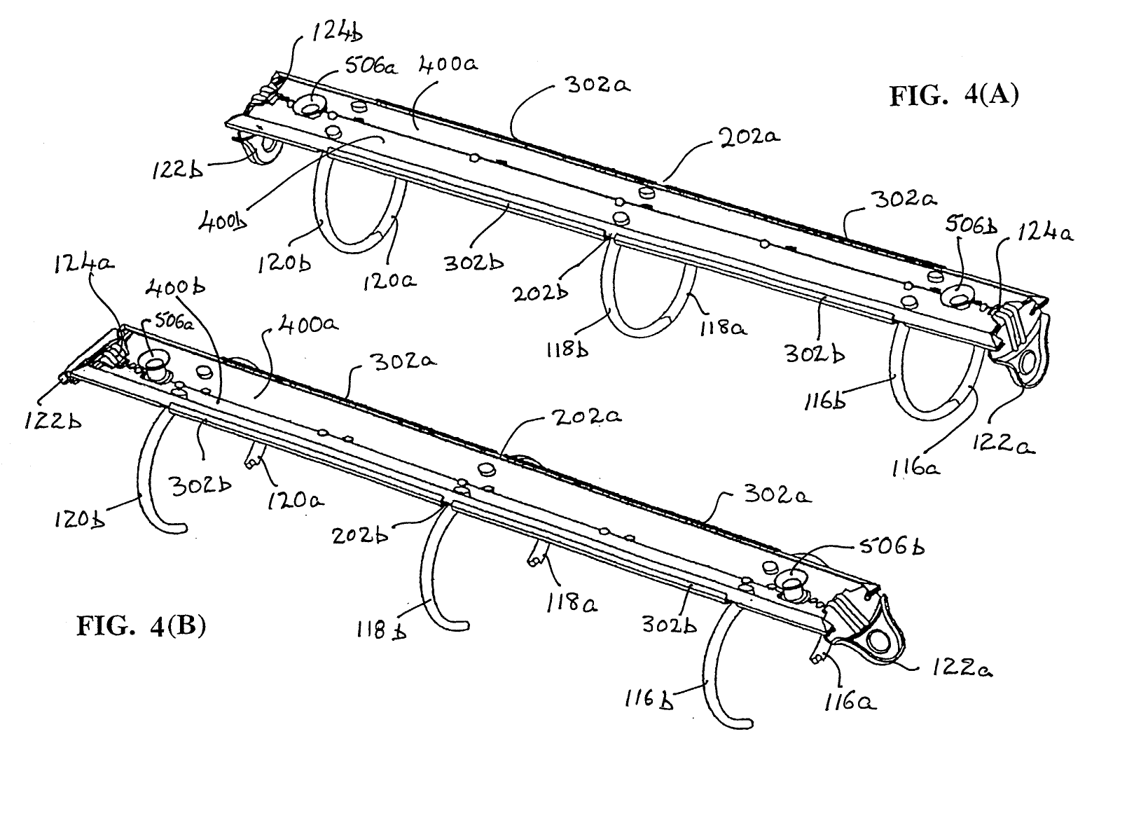

If cover 200 is made of an elastically deformable material, e.g., a relatively stiff plastic or metal, an even simpler way to place and retain it over element 108 would be to provide the element with parallel opposite curved-in side elements 302a, 302b, as best understood with reference to FIGS. 3(A), 3(B), 4(A) and 4(B). Note that the side elements 302a, 302b are interrupted centrally by corresponding lateral notches 202a and 202b, respectively. Such an elastically deformable cover 200 can be readily slid into position and pressed to snap-fit over element 108.

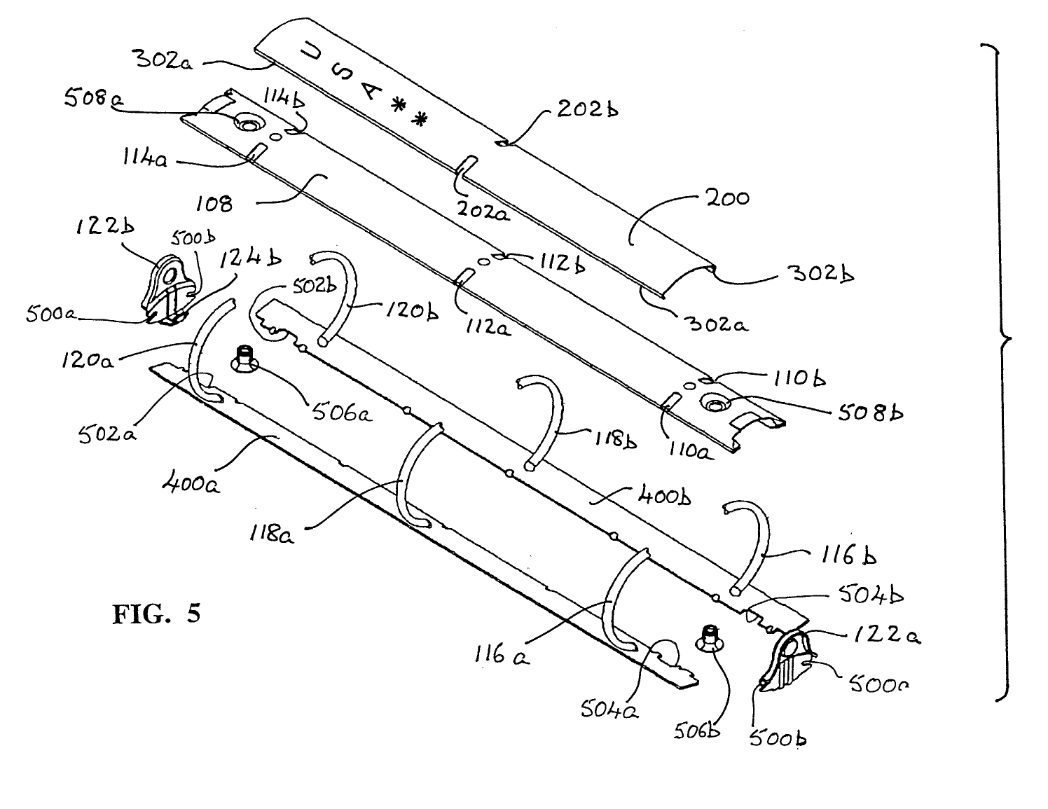

There are, of course, other elements of item-retaining housing 100 that cooperate and assume different force-biased positions to make it possible for a user to add to or remove items from the conventional ring binder as used with the present invention. The most important of these are a pair of elongate split ring bases 400a, 400b, which are best understood with reference to FIGS. 4(A), 4(B) and 5. As best seen in FIG. 5, base 400a has rivet-mounted to it split ring portions 116a, 118a and 120a. Similarly, base element 400b has rivet-mounted to it split ring elements 116b, 118b and 120b. The pair of bases 400a and 400b lie in aligned contact with each other inside the curve of element 108 and are forcibly constrained to maintain this contact by curved-in side edge portions thereof. Pivotable L-profiled levers 122a and 122b, either individually or together, are employed by the user to apply force to base elements 400a and 400b simultaneously to force them against the elastic biasing force imposed by the latters' forcibly constrained disposition under and within the sides of element 108. When levers 122a, 122b are forcibly pressed outwardly, their lower arms 124a, 124b respectively move upward to forcibly lift the inner edge portions of split ring base elements 400a, 400b. Upon the application of sufficient force in this manner, split ring base elements 400a, 400b temporarily elastically deform element 108a and flip over to a position such that split ring arms 116a, 116b, 118a, 118b, and 120a, 120b spring apart to their open position and enable a user to remove or add to items retained in the ring binder. This is best understood with reference to FIGS. 3(A) and 3(B).

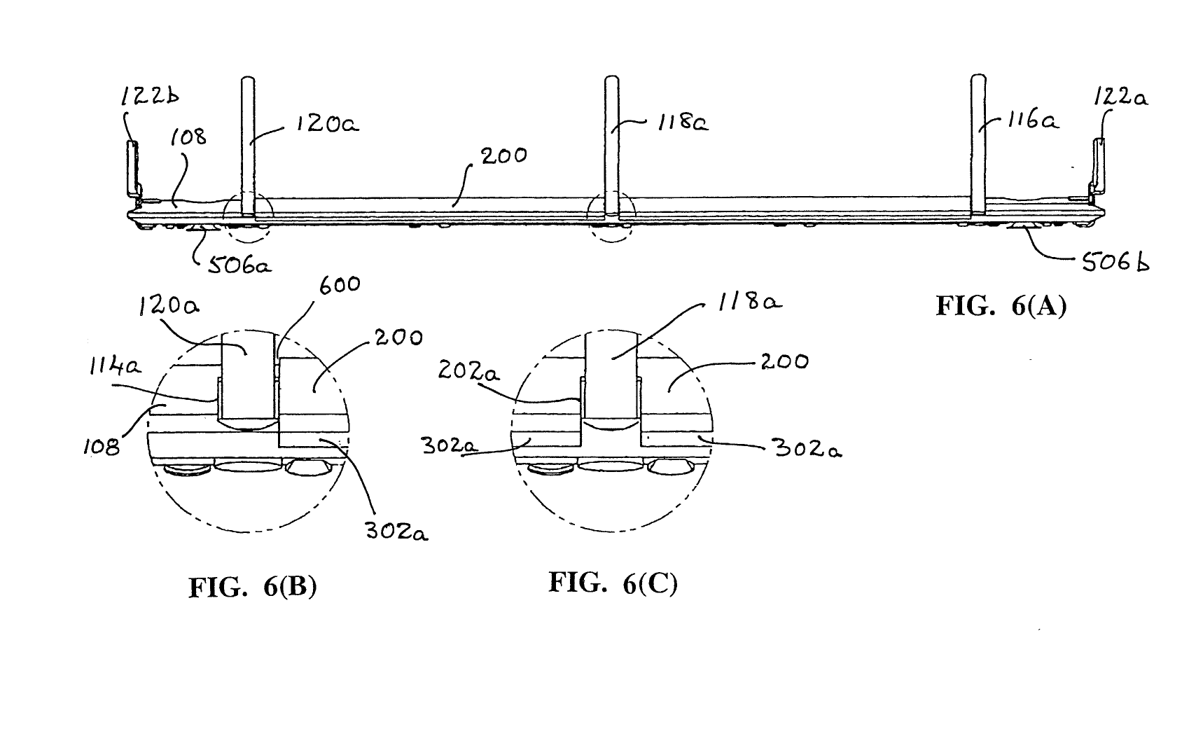

As is readily understood with reference to FIGS. 6(A)-6(C), the cover 200 according to the first embodiment has a length somewhat shorter than the longitudinal distance between the inner edges of split rings 120a, 120b at one end and 116a, 116b at the other. This leaves a small gap such as gap 600 at each end and ensures that there is no frictional interference or difficulty arising from forcible contact between the split rings and the immediately adjacent ends of cover 200. In other words, the location of cover 200 correctly will ensure against interference by it with opening and closing motions of the split rings while also ensuring that such motion of the split rings does not tend to dislodge it from its close attachment to the underlying housing element 108. Similarly, with central notch 202a in cover 200 sized adequately, there should be no physical interference there between split rings 118a, 118b and cover 200.

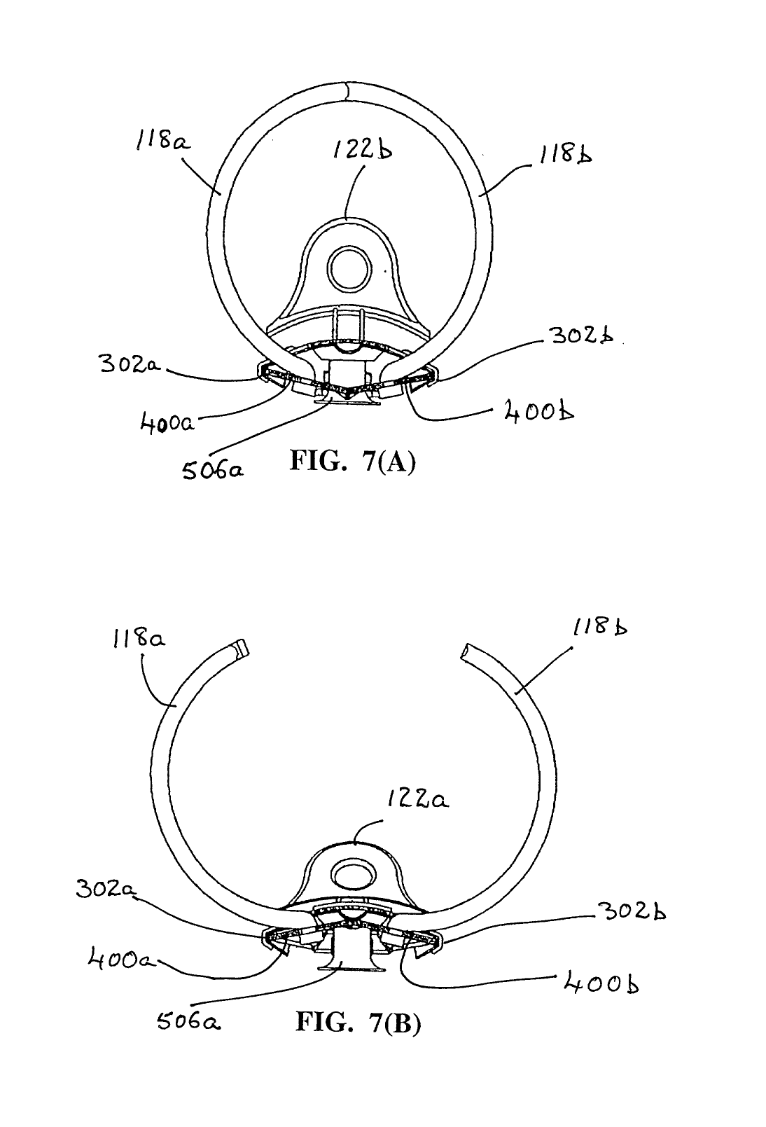

Reference to FIG. 7(A) further clarifies some of the previous discussion. Thus, for example, FIG. 7(A) clarifies the term “rivet mounted” to explain the connection between split rings 118a, 118b and base elements 400a, 400b respectively. This figure also shows the base elements 400a, 400b abutting each other along their inside edges so as to form a shallow “V” profile in cross-section when the split rings in their closed position—they must be to retain items in the ring binder. FIG. 7(B), by contrast, shows base elements 400a, 400b still in abutting contact their inner elongate edges, but now in a flipped-over position so that their mutual cross-sectional profile is like an inverted “V”, and the corresponding split ring portions are moved apart to their “open” state during which items may be removed or added to the contents of the ring binder.

As will be readily appreciated by persons skilled in the mechanical arts, by suitable selection of size, mechanical strength and shape, the cooperating base elements 400a, 400b, and their interaction with the inside surfaces of base element 108 at their respective outer edges, generates a biasing force which must be overcome by forcible movement of “L” shaped levers 122a, 122b. Note, also, that the opposite ends of base element 108 are shaped at their respective ends to loosely fit into correspondingly formed lateral notches 500a, 500b in each of the lever elements 122a, 122b which are geometrically similar to each other. Furthermore, the opposite ends of base element 108 are formed to have notches into their inner edges, at 502a, 502b and 504a, 504b that are shaped and sized to loosely accommodate a corresponding pair of hollow metal ring eyelets 506a, 506b. These eyelets serve, in part, to maintain proper alignment of the other cooperating elements in the item housing structure. They may also be employed to serve another purpose as discussed more fully below with reference to yet another embodiment of the invention.

The above description of the first embodiment may be summarized as follows: an information-bearing cover 200 may be made of a suitable material of selected thickness, with useful information perceptibly provided on a visible surface, and may be adhered or snap-fitted to the central conventional item-retaining element 108 found in known ring binders. This enables a user to see the information being conveyed on the visible elongate portion of the cover independently of whether there are items on one side or both sides of the center of the ring binder. Furthermore, information may also be conveyed in Braille to blind persons who may run their fingers along and over the outer surface of element 200. Since it is entirely logical to expect that ring binders may contain items such as documents bearing information in Braille, the use of such an embodiment follows naturally. In this manner, the present invention very economically and simply makes information available to both sighted and blind individuals when used in conventional ring binders as discussed above. Raised Braille elements and visually-perceptible data can be provided simultaneously on the cover for optimum utility thereof.

As noted earlier, frequent and prolonged use of conventional ring binders may eventually cause element 108 to suffer some mechanical yield, i.e., flattening of the curved profile, and this would naturally lead to a diminished bias force exerted by on base elements 400a, 400b to ensure that the split rings in their “closed” position will firmly remain so. Such a diminished retention of items can, as noted previously, cause inertia or gravity-induced forces to suddenly cause a heavily filled binder to release the split rings. The contents may thus be spilled and need to be resorted and replaced in a stronger ring binder. The present invention, in another embodiment, enables a user to supplement the residual biasing force available from an old element 108 to retain the split rings in their closed position. This is discussed below with particular reference to FIGS. 14(A) and 14(B).

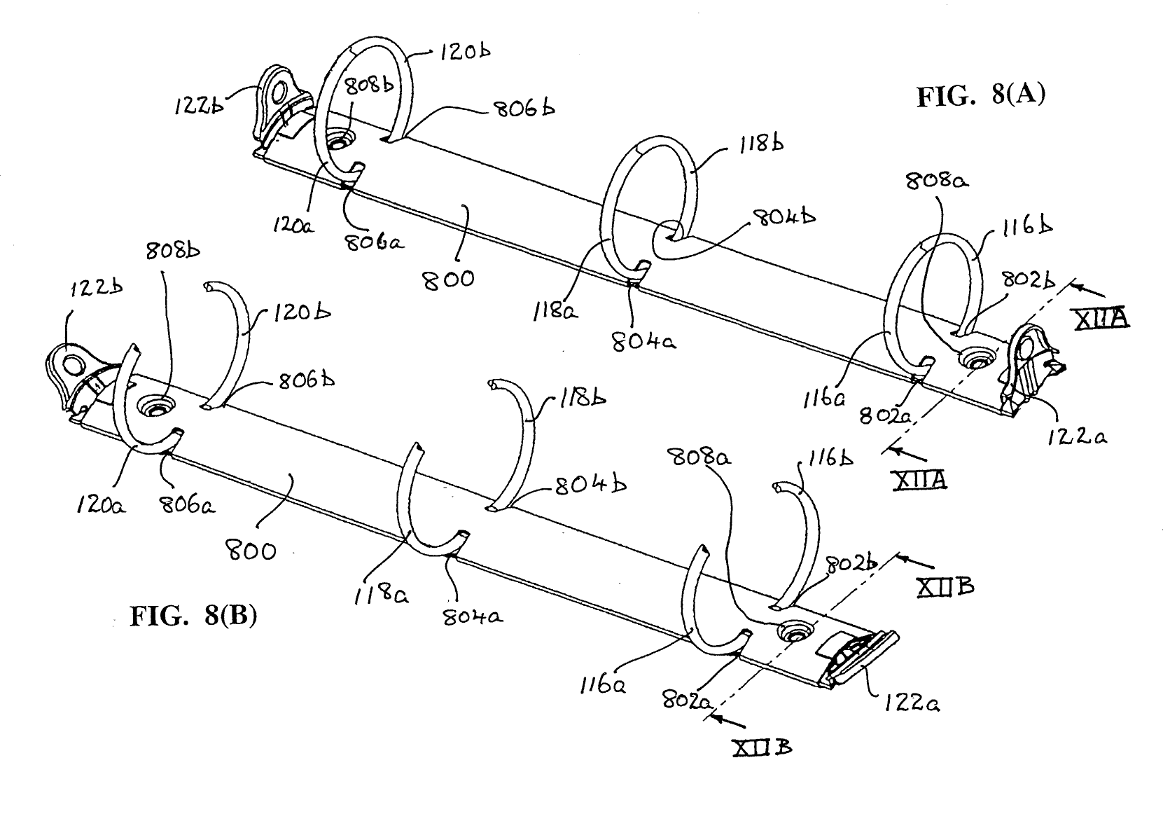

In a second embodiment of the present invention, as best understood with reference to FIGS. 8(A), 8(B), 9(A), 9(B) and 10, a cover element 800 which is longer than the previously discussed cover element 200 of the first embodiment, may be utilized to provide a larger surface area and greater visibility of its end portions even when the ring binder is closed with items contained therein. Cover 800 in this embodiment is approximately the same length as element 108 to which it is fitted and which it covers. As with previously-discussed cover 200, cover 800 may be made of any suitable material to any suitable thickness and may be provided with any suitable symbols, numerals, letters, barcodes or the like to convey useful information, visually or in Braille, related to any selected aspect of items contained in a particular ring binder.

As best seen in FIGS. 8(A) and 8(B), cover 800 is provided with three pairs of notches to accommodate corresponding split rings. These notches 802a, 802b, 804a, 804b, and 806a, 806b are made large enough to avoid physical interference when corresponding split rings 116a, 116b, 118a, 118b, and 120a, 120b are moved between their “open” and “closed” positions. Furthermore, cover 800 is provided with a pair of apertures 808a, 808b which are disposed at the locations of hollow eyelets 506a, 506b respectively.

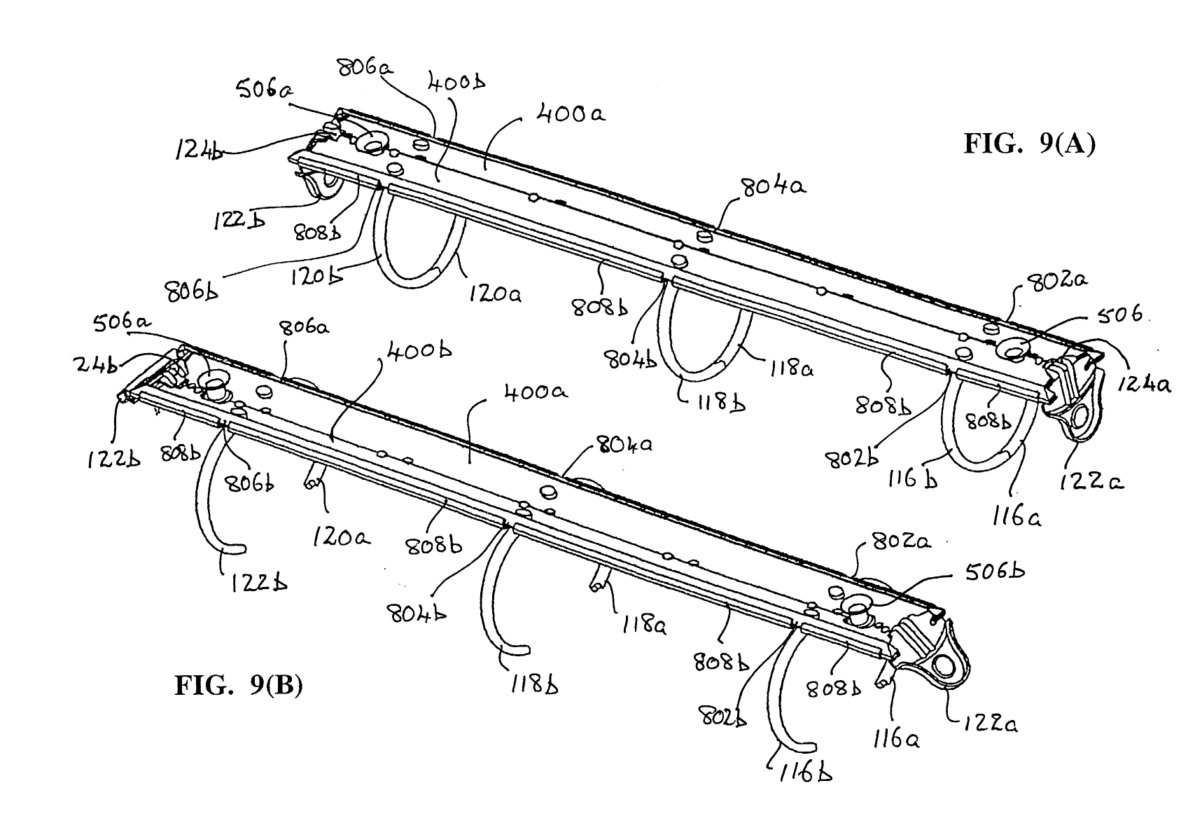

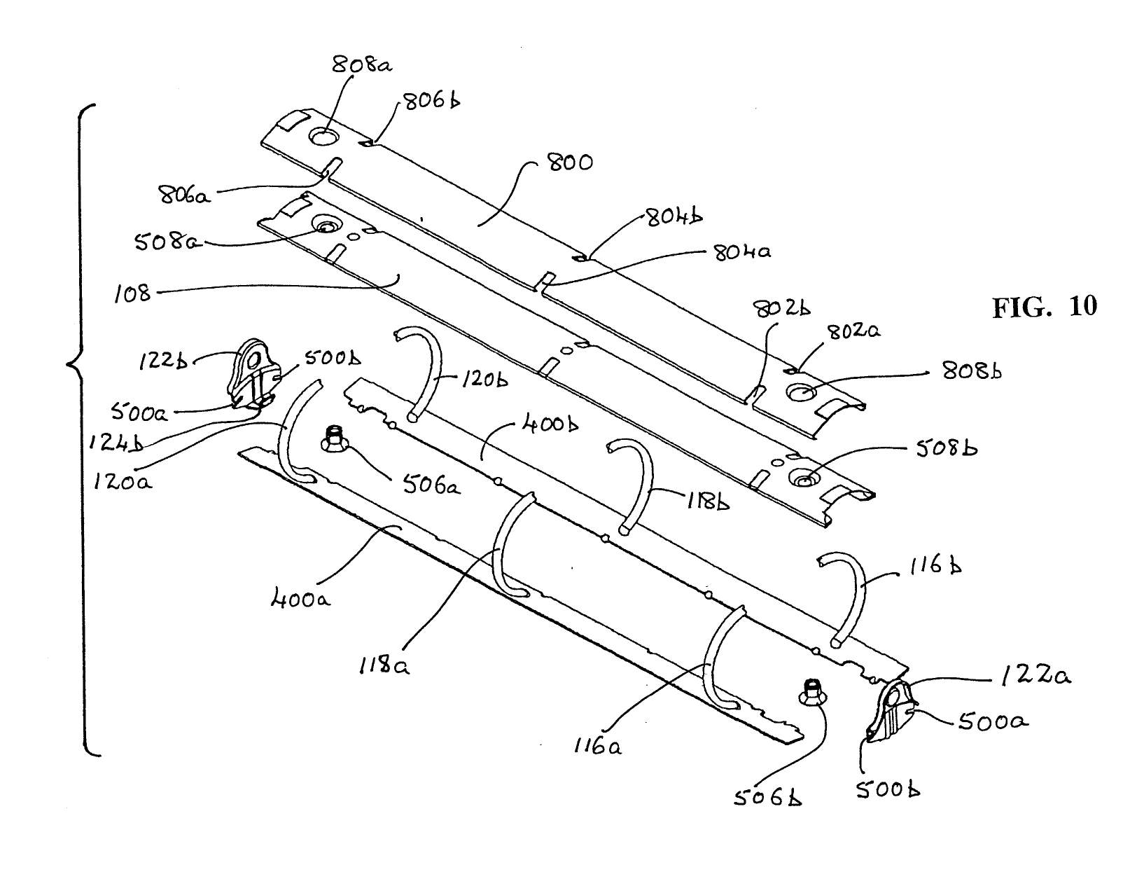

FIGS. 9(A) and 9(B) serve the same purpose with respect to the embodiment illustrated in FIGS. 8(A) and 8(B) as was served by FIGS. 4(A) and 4(B) with respect to the first embodiment.

FIG. 10 presents an exploded view of the item-retaining elements of the ring binder together with cover 800 according to the second embodiment, in a manner similar to FIG. 5 illustrating the first embodiment.

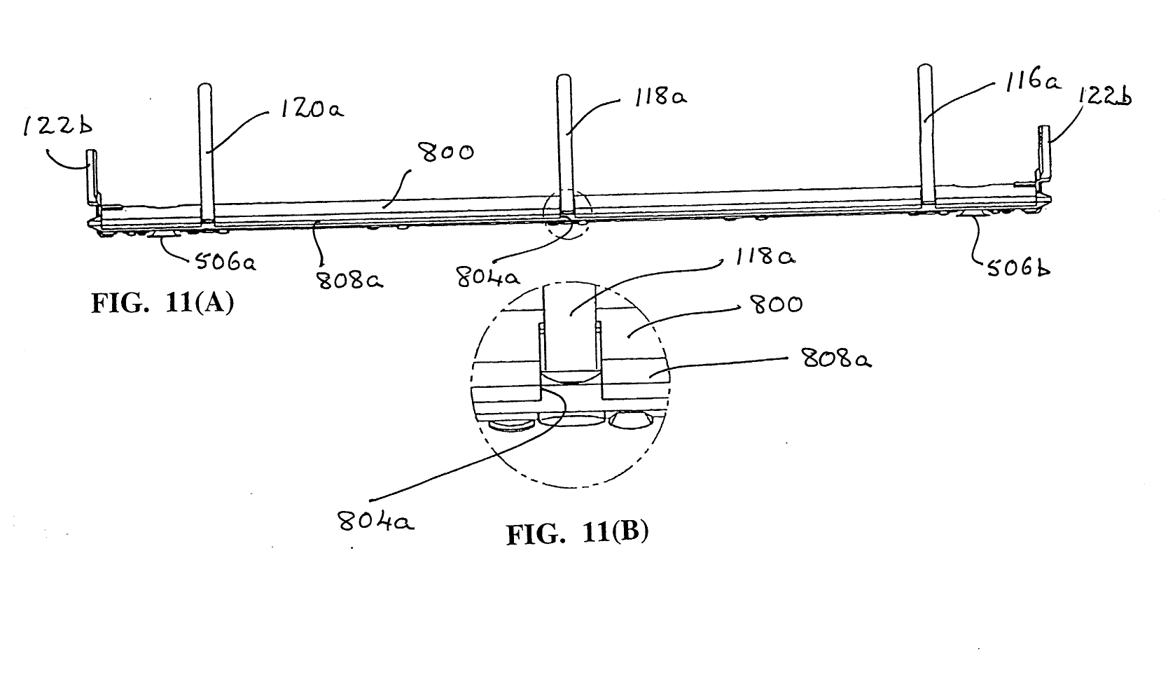

FIGS. 11(A) and 11(B), like FIGS. 6(A)-6(B), are intended to clarify that notches such as notch 804(A) formed in the cover 800 according to the second embodiment are sized and positioned to avoid any physical interference with corresponding split rings such as, for example, 118a which is best seen with reference to FIG. 11(B).

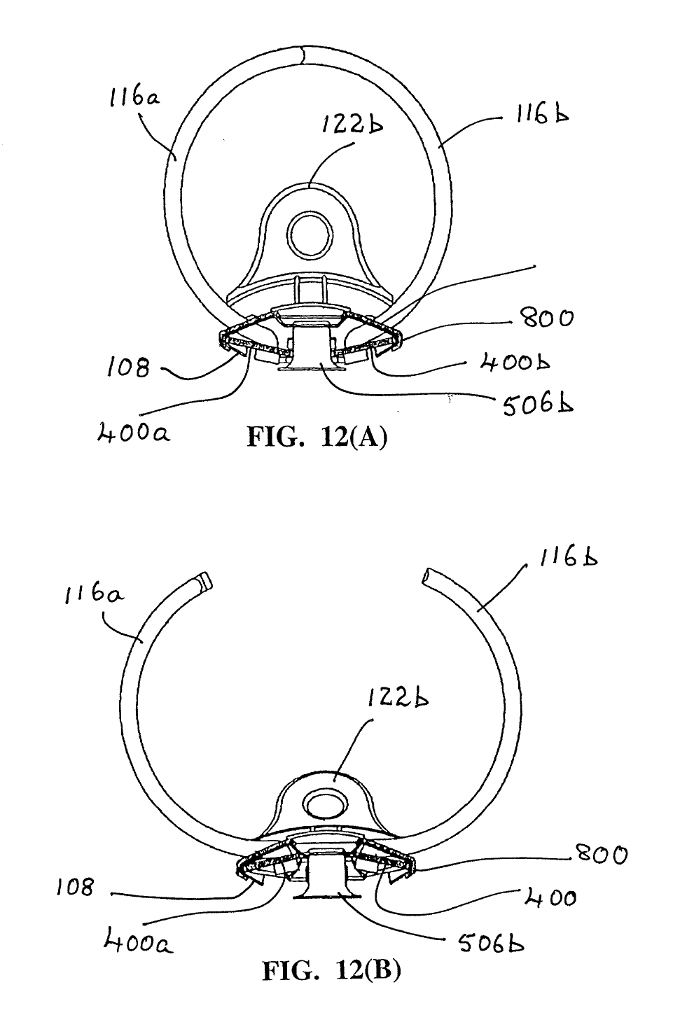

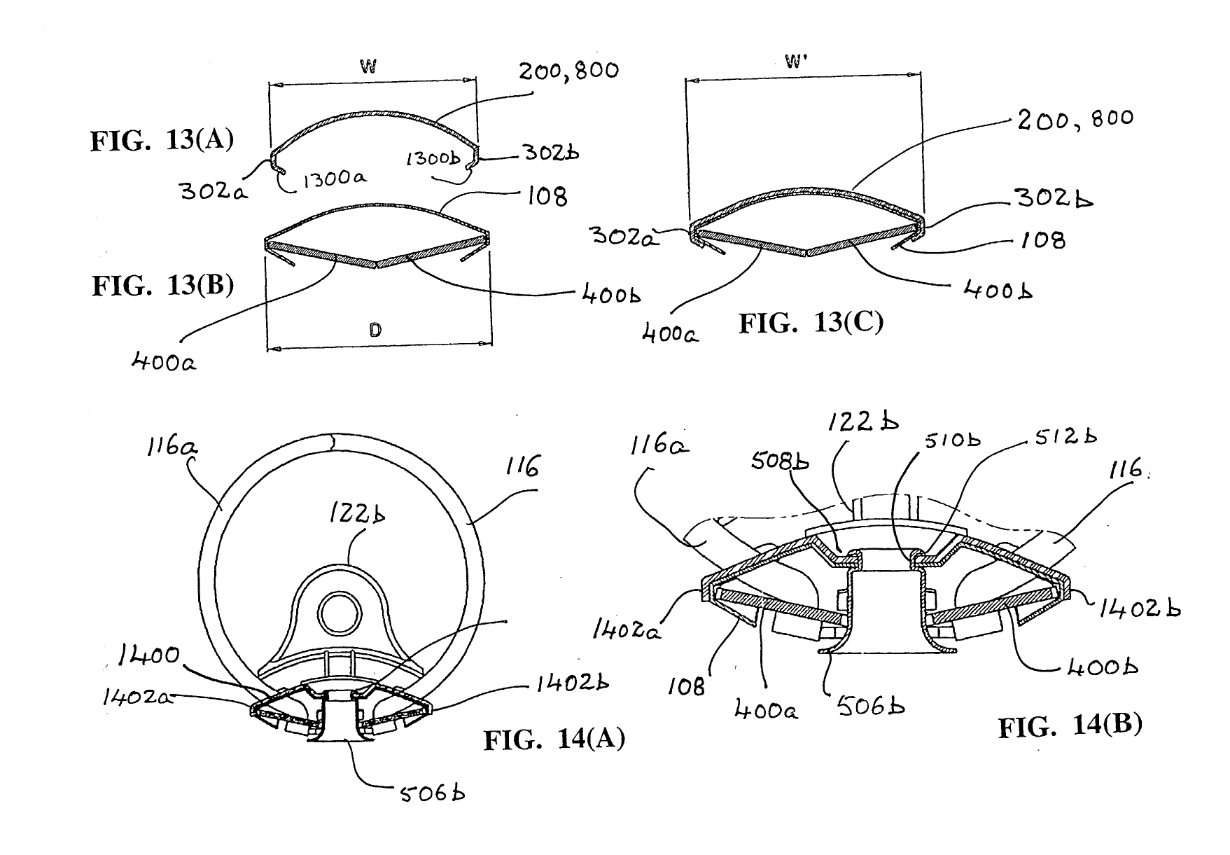

Also, FIGS. 12(A) and 12(B), like FIGS. 7(A) and 7(B), are intended to illustrate the relationships of base plates 400a and 400b in their working positions with respect to element 108 which constrains them against each other and provides a constant biasing force which must be overcome by operation of levers 122a and/or 122b to move the split rings between their “open” and “closed” positions. This is probably even better understood with reference to FIGS. 13(A)-13(C).

FIG. 13(A) is a transverse cross-sectional view across the full width of either of the first embodiment 200 or the second embodiment 800. (This cross-section is being taken across the full traverse width of the cover and not at any of the notches formed therein.) Note that side portions 302a and 302b in both the first and the second embodiment are conveniently formed to have re-entrant edge portions 1300a, 1300b. FIG. 13(B) is a similar transverse cross-section across element 108 of the item-retaining housing portion of the ring binder together with base elements 400a, 400b in the positions which they must assume for the corresponding split rings supported by them to be in their “closed” positions, i.e., in the positions in which they would securely retain any items placed in the ring binder. Finally, FIG. 13(C) is a transverse cross-section across the full width of the cover 200 or 800 as would be the case when the invention is in use.

Referring again to FIGS. 13(A)-13(C), note that the unstrained, i.e., relaxed, transverse width of either cover 200 or 800, if made of a fairly stiff material, will be “W”. Similarly, with base elements 400a and 400b as shown in FIG. 13(B), the outside maximum transverse width of element 108 is “D”. It is important to note, as illustrated in FIGS. 13(A) and 13(B) that “W” is initially slightly less than “D” by an amount determined by the material, the thickness and the corresponding mechanical stiffness of the cover 200 or 800. As best seen in FIG. 13(C), when the cover 200 or 800 is in its working position, fitted over element 108, the maximum outside width will now be “W” which will be larger than both “W” and “D”. In this state, the material of cover 200 or 800 is elastically deformed and is forcibly pressing inward on the outer edge portions of element 108. The degree to which such a pressing force is exerted will, of course, depend upon the mechanical stiffness of cover 200 or 800 which, in turn, will depend upon its initial shape, width and thickness, and the elasticity and mechanical stiffness of the selected material.

As a practical matter, if element 200 or 800 is made of a relatively thin, compliant material such as paper, fabric, plastic covered fabric or the like, it is probably best applied to its working position over element 108 by the use of an adherent as previously discussed. However, if the selected material is relatively stiff, e.g., a stiff plastic, metal, composite or the like, the form illustrated in FIG. 13(A) is probably more useful and practical. For such a relatively stiff but elastically deformable cover 200 or 800, the user may most conveniently grasp the cover with both hands, press the curved central portion and thereby slightly deform the cover to then snap-fit it over element 108 with the notches in the cover correctly aligned so as not to interfere with the split rings which move within corresponding notches formed in element 108. If the mechanical stiffness of such a cover 200 or 800 is significant, then it may have a significant effect on operation of base elements 400a, 400b in their movement between their “open” or “closed” positions. In other words, such a cover 200 or 800 will simply augment the intended function of element 108 with respect to the biasing of base elements 400a, 400b to a predetermined degree. If, in the course of time and use, cover 200 or 800 of this type becomes weakened, it may be readily replaced to restore the stiffness with which the item-holding elements cooperate to hold items in the ring binder.

In FIG. 14(A) there is shown a third embodiment of the present invention in which the cover 1400 may be of a length comparable to that of cover 200 or may be longer and comparable in length to that of cover 800 discussed previously. This cover 1400, however, lacks the re-entrant edge portion such as 1300a, 1300b as discussed above with particular reference to FIG. 13(A). In other words, as best seen in FIG. 14(B), cover 1400 according to the third embodiment has only relatively short downward edge portions 1402a, 1402b without the re-entrant segments. Furthermore, cover 1400 has its through apertures actually formed to have a somewhat dished form to correspond to respective dished apertures 508a, 508b in element 108. This, also, is better understood with reference to the enlarged view of FIG. 14(B). Through each of these pairs of co-aligned apertures near each end of element 108 and cover 1400 fitted thereover, to secure cover 1400 to element 108, there is passed a corresponding upper end such as upper end 510b of hollow eyelet 506b. The permanent securing of such a cover 1400 to the corresponding element 108 over which it is fitted is best obtained by mechanically turning over the extreme edge portion 512b of the eyelet so that it curves downward to force the edge of end 510b against cover 1400. In other words, the upper edge of each eyelet serves as a rivet head in this manner, and permanently attaches cover 1400 over element 108 in that particular ring binder housing. Such a cover 1400 is probably best made of a relatively strong metal or composite, although a stiff plastic may also be utilized. The thickness, material strength, and initial curvature of the element 1400 will subsequently determine the additional stiffness that it provides to the underlying cover 108 to generate a corresponding supplemented bias force that must be overcome for base elements 400a, 400b to move from their “open” to their “closed” position and vice-versa.

In summary, although the second embodiment for cover 800 will add to the stiffness of element 108, for heavy-duty ring binders it may sometimes be more convenient to permanently attach a cover such as that of third embodiment 1400 to the item-containing housing.

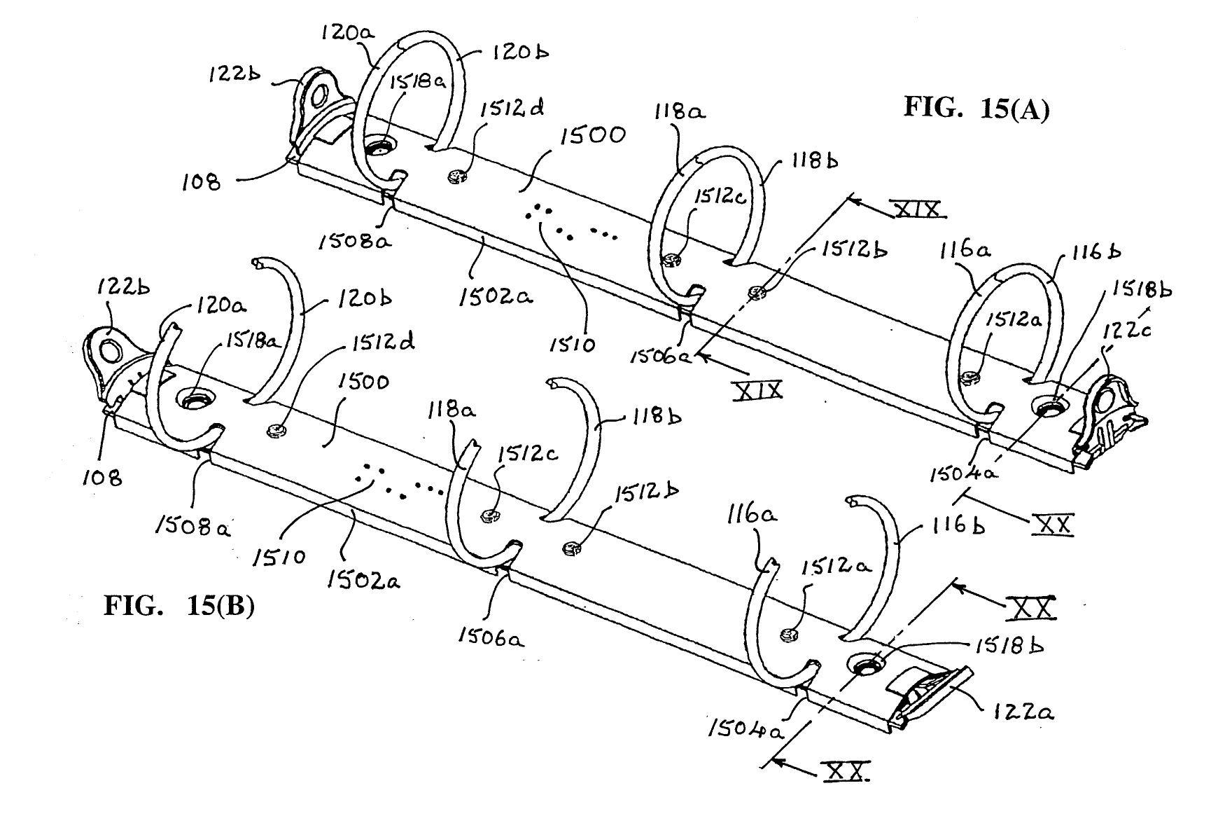

FIGS. 15(A) through 22(B) relate to a fourth embodiment cover 1500 which has some structural similarities to cover 1400 but is attachable to element 108 in a different manner as explained below.

Cover 1500 is similar to cover 800 discussed previously in that it has an overall length only slightly shorter than the length of element 108 which it virtually completely covers in use. To accommodate the exemplary three sets of split rings 116a, 116b, 118a, 118b and 120a, 120b, respectively, cover 1500 has formed into it at its sides, at corresponding locations, notches 1504a, 1504b, 1506a, 1506b and 1508a, 1508b. These notches are sized to ensure that there will be no physical interference by them with the split rings that move within them during operation of the ring binder.

Note, incidentally, that Braille-type information, identified by the numeral 1510 in FIGS. 15(A) and 15(B), may be provided on this cover or on any of the others discussed previously provided the selected material permits it. Soft compliant paper or plastic may not readily permit the provision of embossed markings in Braille but stiff materials should in any of the disclosed embodiments. However, even on soft materials the use of relatively thick deposits may be applied to provide recognizable markings perceptible to touch.

It should be noted that cover 1500 is intended to be made of a relatively stiff material, e.g., a plastic, a metal, or a composite that is strong enough to provide the previously discussed supplementary bias force to reinforce the inherent biasing action of the sides of underlying element 108 on base elements 400a, 400b to which corresponding halves of various split rings are riveted.

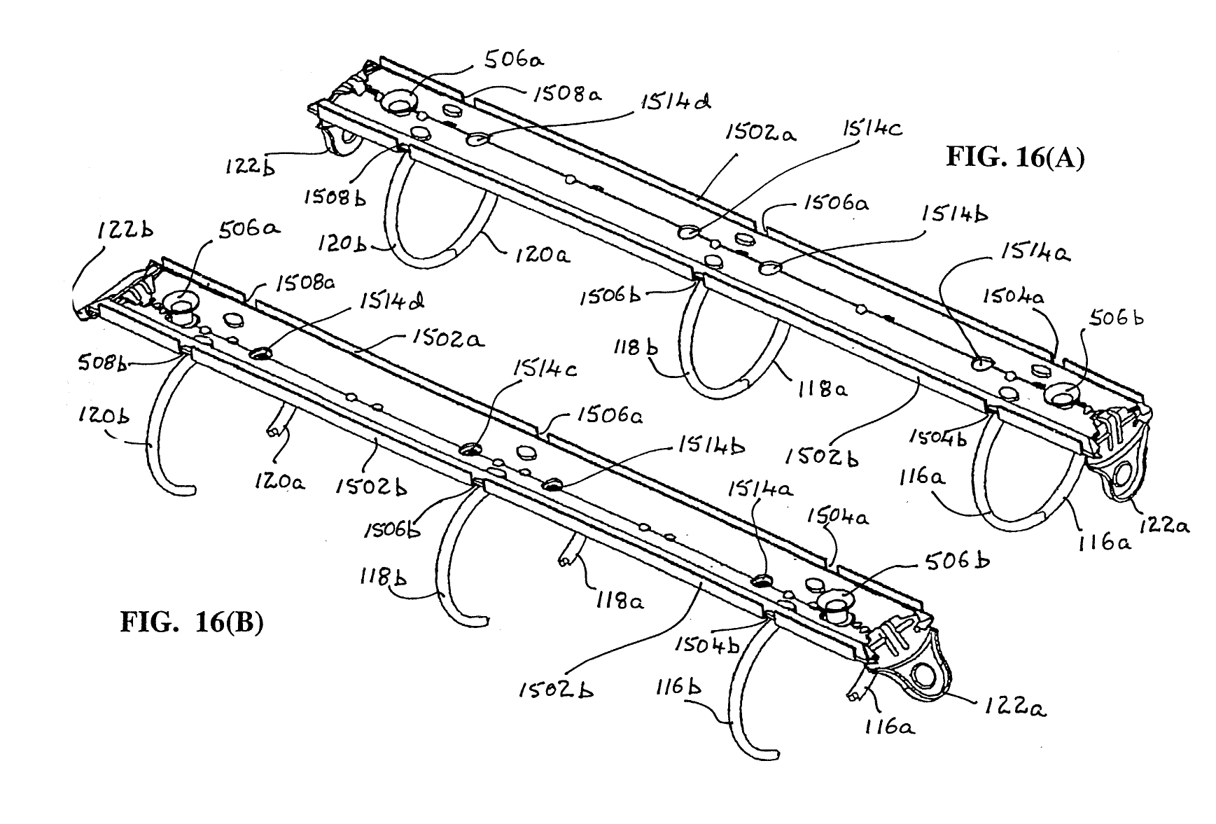

Attention will now be focused on certain structural features of cover 1500, with reference to FIGS. 16(A) through 18(B). First, it should be noted that cover 1500 has two parallel elongate outside side elements 1502a, 1502b which are spaced apart to tightly fit to corresponding outside edge surfaces of underlying element 108 during use of this embodiment. Reference to FIG. 19 should clarify how these side elements 1502a, 1502b of the fourth embodiment are preferably somewhat longer than corresponding elements 1402a, 1402b of the third embodiment as discussed with reference to FIG. 14(B) previously. The actual sizing must, of course, depend upon the ring binder with which this particular embodiment is to be used, and is considered a matter of engineering judgment which the manufacturer must exercise with due consideration given to commercial needs, manufacturing convenience and expense, and the like. What is important, however, is that these side elements 1502b, 1502b are strong enough to ensure that the force-bias supplementing aspect of cover 1500 is fully realized during the useful life of cover 1500, and also to protect the underlying metal elements of the item-retaining elements from moisture or corrosive materials as discussed previously.

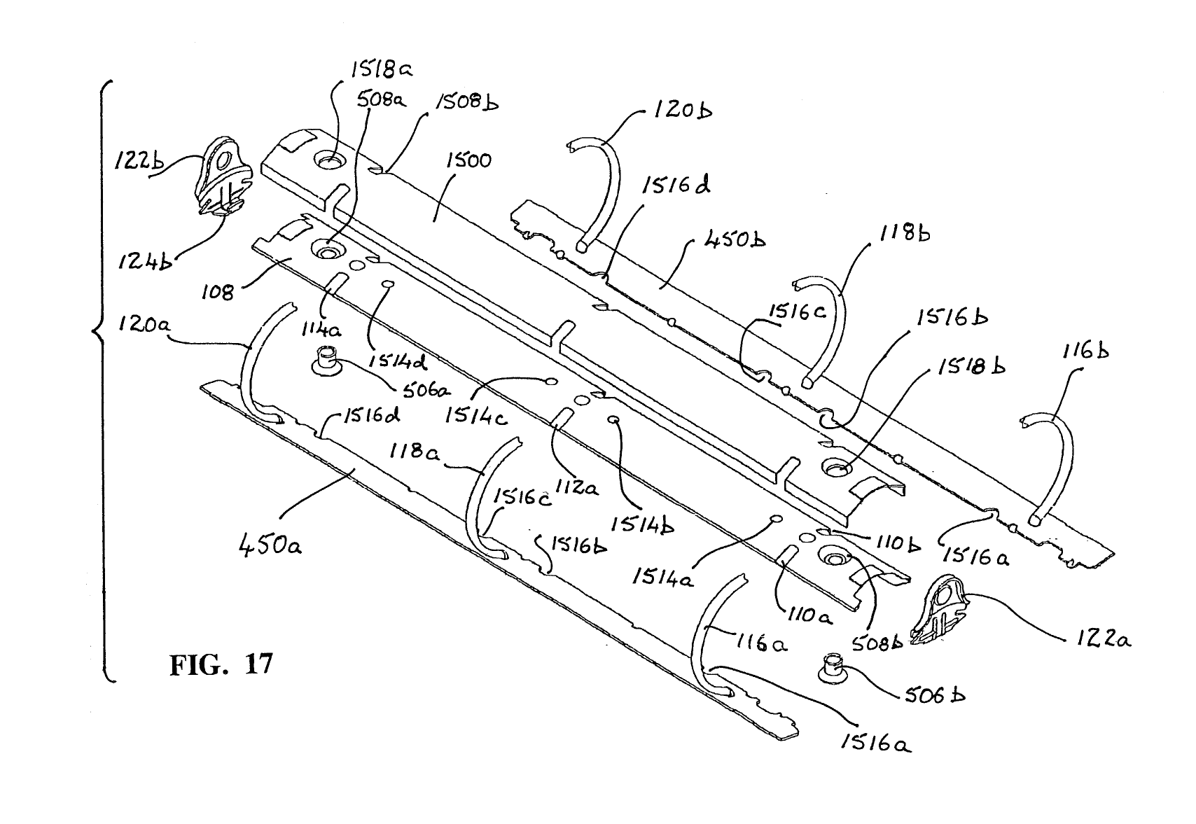

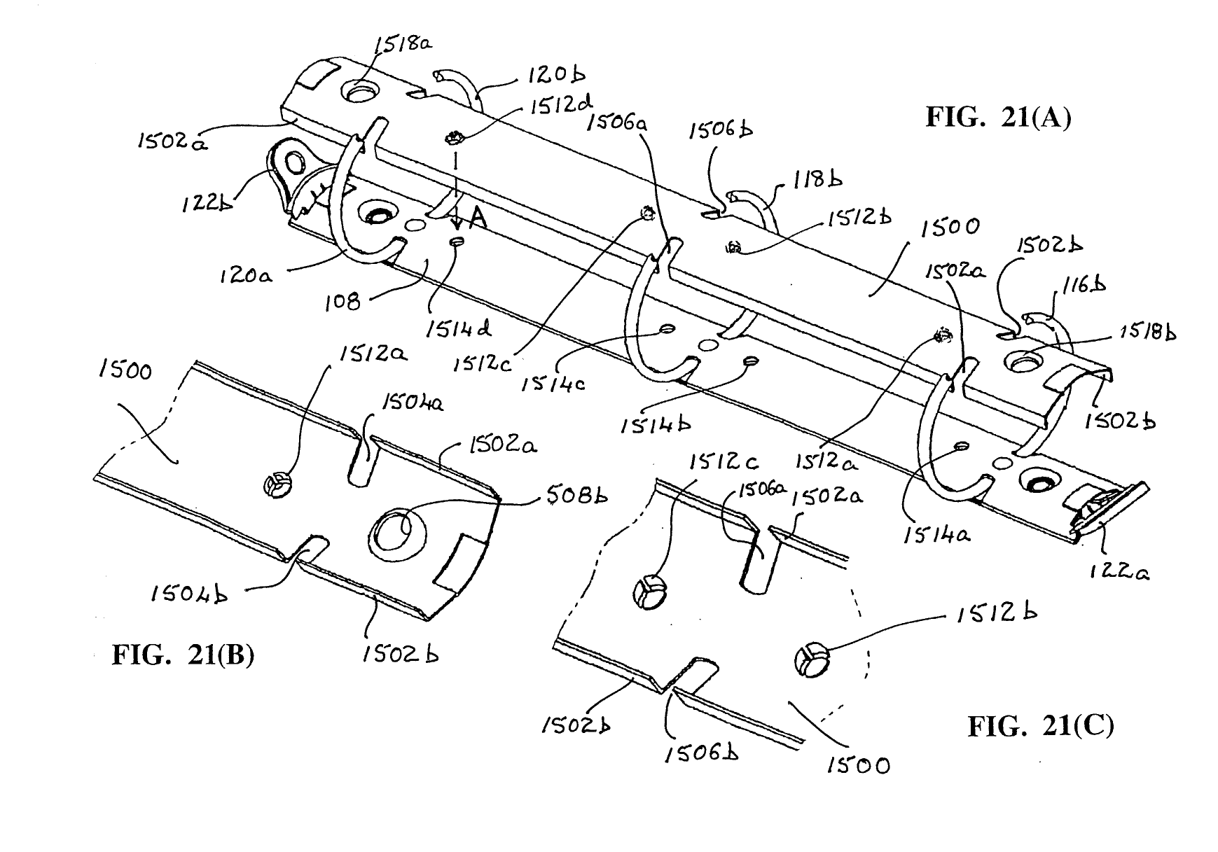

Another interesting aspect of this embodiment is that there are provided a plurality of inwardly extending snap-fit elements. The actual number and disposition of such snap-fit elements is a matter of engineering choice, but it is considered that four of them should be adequate for most foreseeable uses. These snap-fit elements 1512a-1512d are best seen in FIGS. 15(A), 15(B) and 19. Each extends from the surface of cover 1500 which is on the same side as the distal edges of side elements 1502b, 1502b. This is probably best understood with reference with FIGS. 21(B) and 21(C). These last two figures also illustrate how the distal end portions of these snap-fit elements are split, preferably by three radial cuts, to permit the resulting sectors to extend in cantilevered manner. The distal ends of elements 1512c-1512d are preferably rounded or conically chamfered, as best seen in FIG. 19. The material of which cover 1500 is made must be selected to have sufficient strength and elasticity to ensure that the cantilevered sectors of elements 1512a-1512d will flex inward when cover 1500 is placed over element 108 and forced towards it by the user so that they may snap-fit into correspondingly located and suitably sized apertures 1514a-1514d which are best seen in FIG. 17. To use this embodiment, therefore, it is necessary that such corresponding apertures be available in element 108 to receive in snap-fitted fashion the elements which will secure cover 1500 to the item-retaining housing of the ring binder with which it is to be used.

It should be noted, in passing, that element 108 typically is provided with a pair of centrally aligned, conically shaped, open apertures 508a, 508b to receive respective ring elements 506a, 506b. See, for example, FIGS. 21(A) 21(B). Cover 1500, likewise, has conically-sided open apertures 1518a, 1518b which a user may find useful to align cover 1500 with respect to element 108 before pressing in elements 1512a-1512d into corresponding apertures 1514a-1514d. It should be further noted, as best seen in FIG. 17, that base elements 450a, 450b which respectively support split rings 116a, 116b and the like are formed to have matchingly positioned semicircular cutouts which, when elements 450a and 450b are in position for use, define apertures corresponding to the locations of extensions 1512a-1512d so as to avoid interference with them.

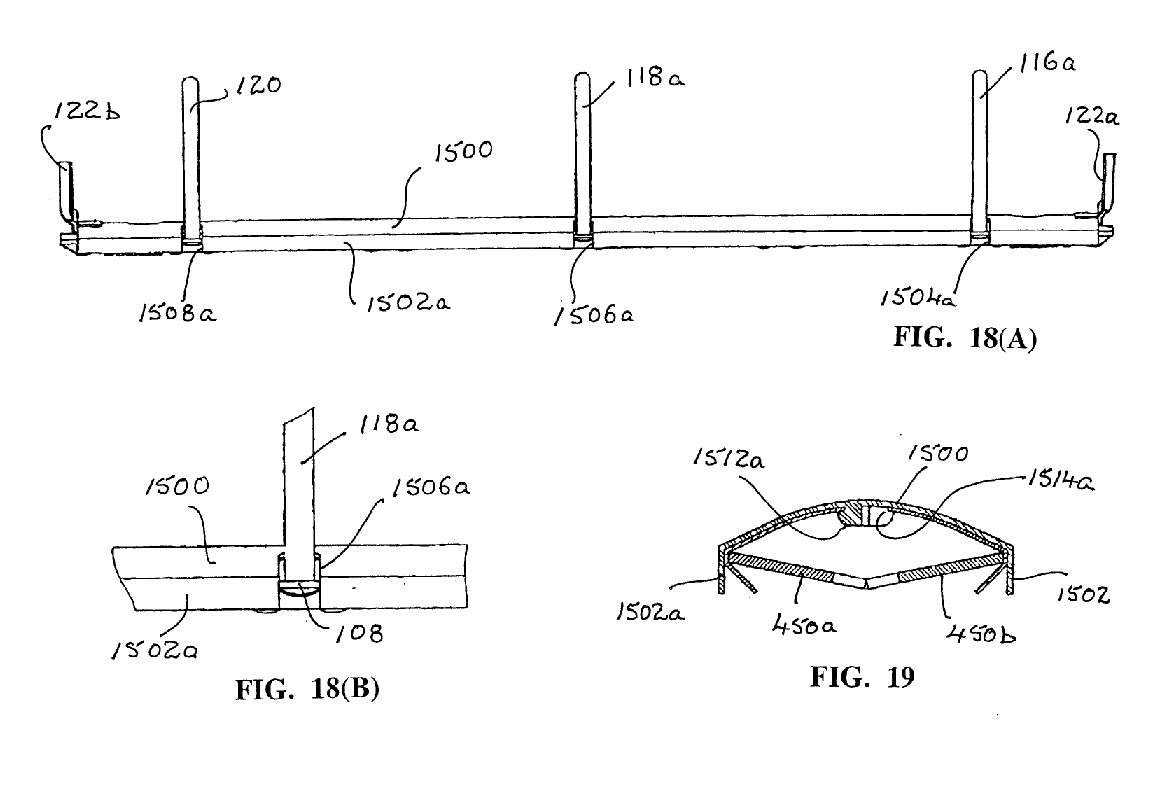

FIGS. 18(A) and 18(B), like FIGS. 11(A) and 11(B) respectively, are intended to clarify how notches 1504a-1508a and 1504b-1508b are all shaped, sized and located to avoid any physical interference with the motion of corresponding split rings such as 116a, 116b, within them during operation of the ring binder to add to or remove items therefrom.

FIG. 19, as previously discussed, clarifies that side extensions 1502b, 1502b of cover 1500 are formed to snugly fit over element 108 and extend to cover the same effectively. Furthermore, FIG. 19 clearly shows how an exemplary extension 1512a extends into and fits securely within aperture 1514a formed in element 108 for use of this particular embodiment.

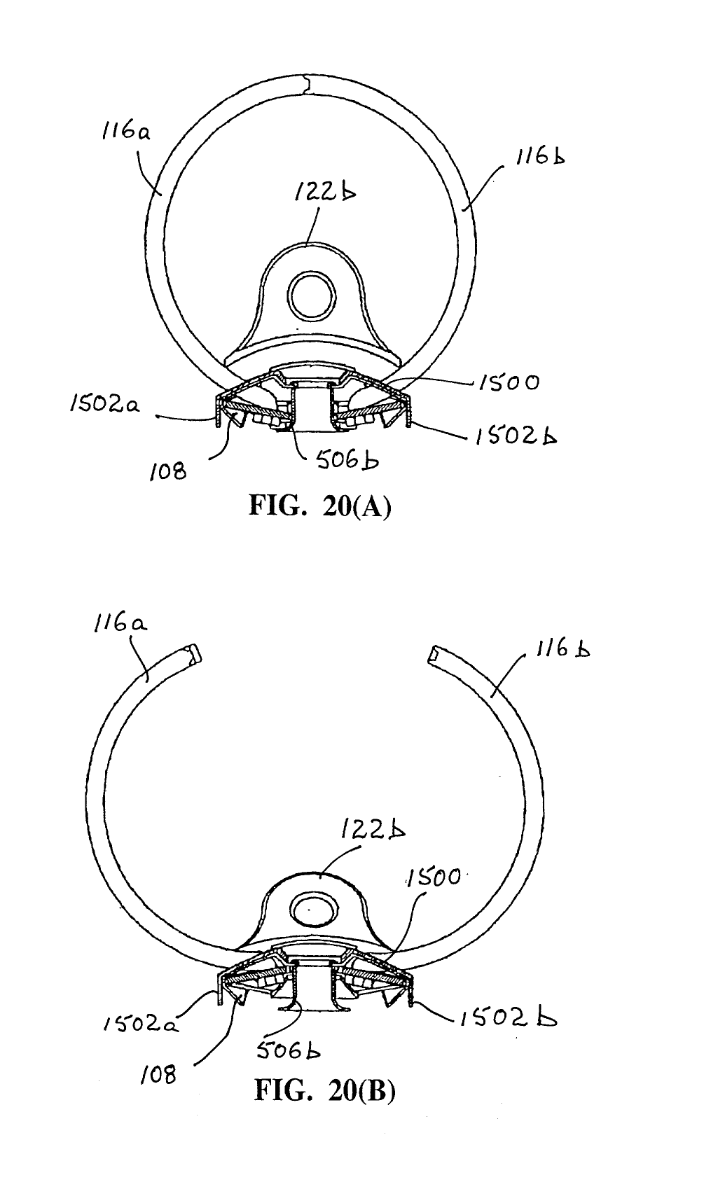

FIGS. 20(A) and 20(B), like FIGS. 12(A) and 12(B) discussed previously, are intended to illustrate in cross-sectional view, at Section XX-XX in FIG. 15(B), how the various elements are disposed when rings 116a, 116b are in their respective “closed” and “open” positions during different conditions of use of the ring binder. Previous discussion is considered adequate to clarify the method of use of cover 1500 to persons of ordinary skill in the art.

FIGS. 21(A)-21(C) together serve to illustrate even more clearly what has been discussed above, principally how extensions 1512a-1512b with their distal split ends fit to apertures 1514a-1514d to secure attachment of cover 1500 to element 108. Note, especially, that in FIG. 21(A) an arrow identified as “A” is utilized to show how extension 1512d is aligned with and engaged by responding aperture 1514d.

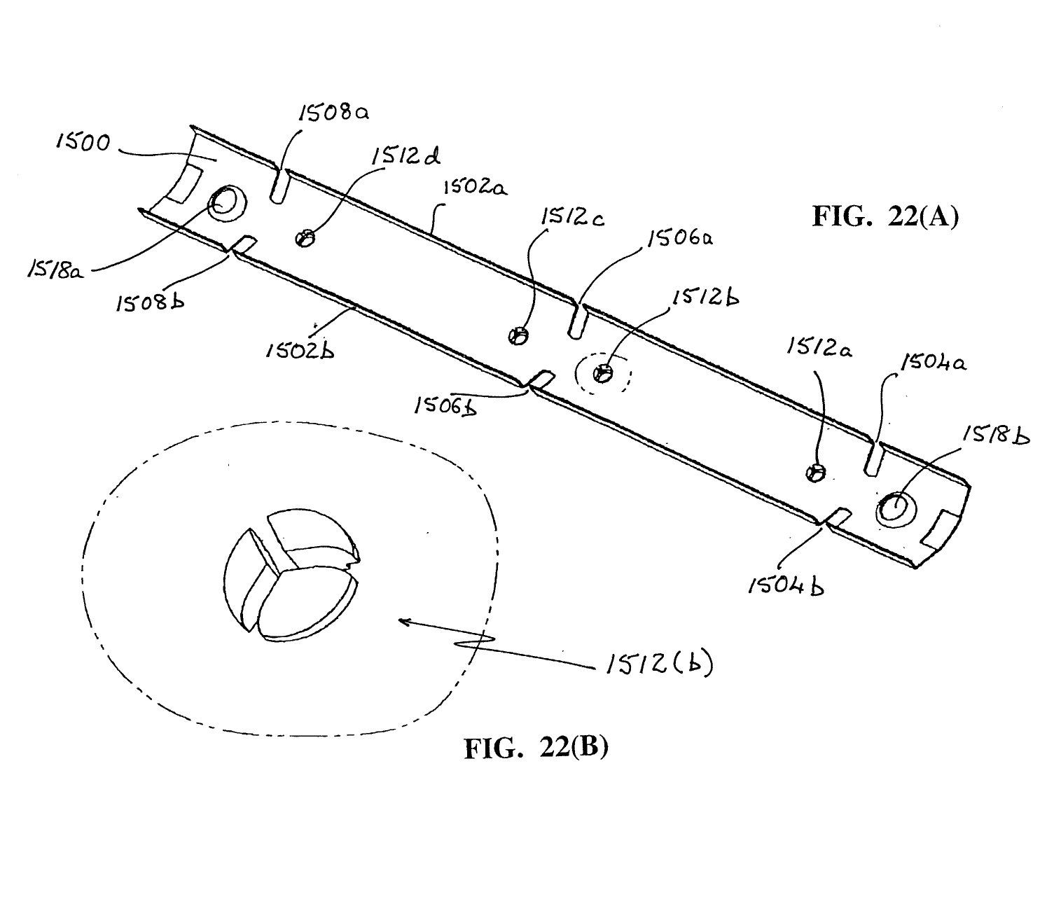

FIG. 22(A) is a perspective view of the underside of embodiment 1500, to more explicitly illustrate the dispositions of extensions 1512a-1512d as well as the conical apertures with open bottoms 1518a and 1518b in the element 108. FIG. 22(B) presents an enlarged view of the distal end of an exemplary extension, namely 1512b, and is intended to clarify how the preferred three cuts are made in the end so that the three sectors so formed have the requisite separation to be snap-fitted into corresponding aperture 1514b in the underlying element 108 for use.

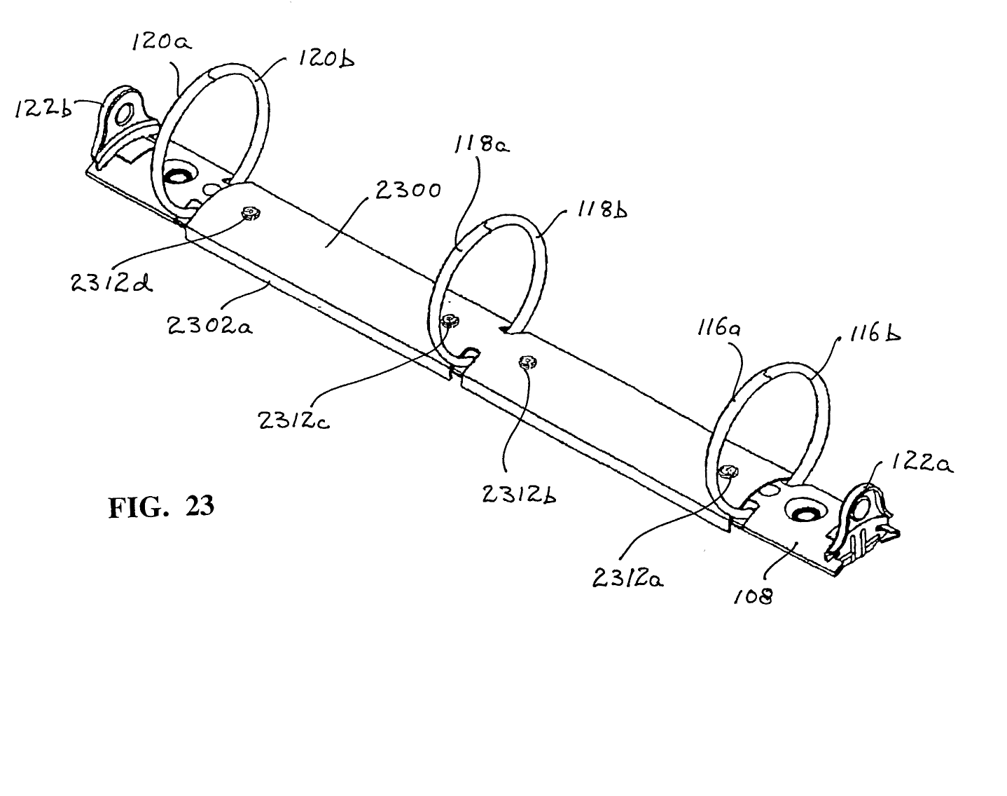

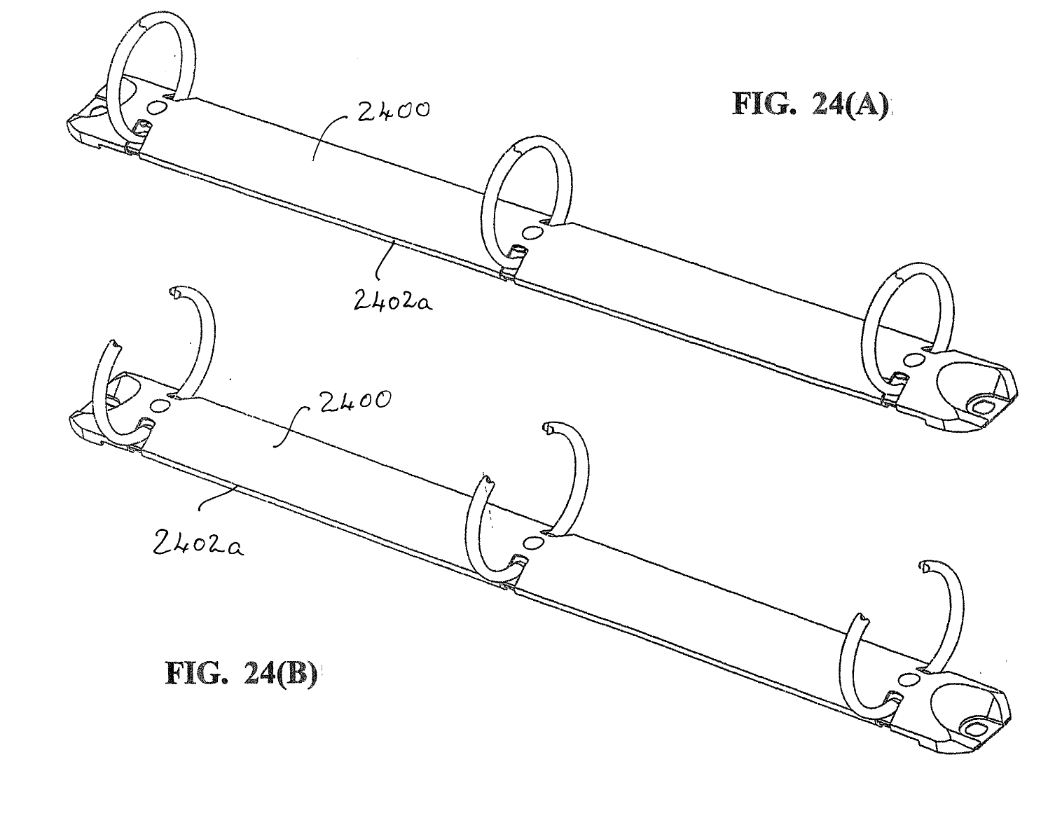

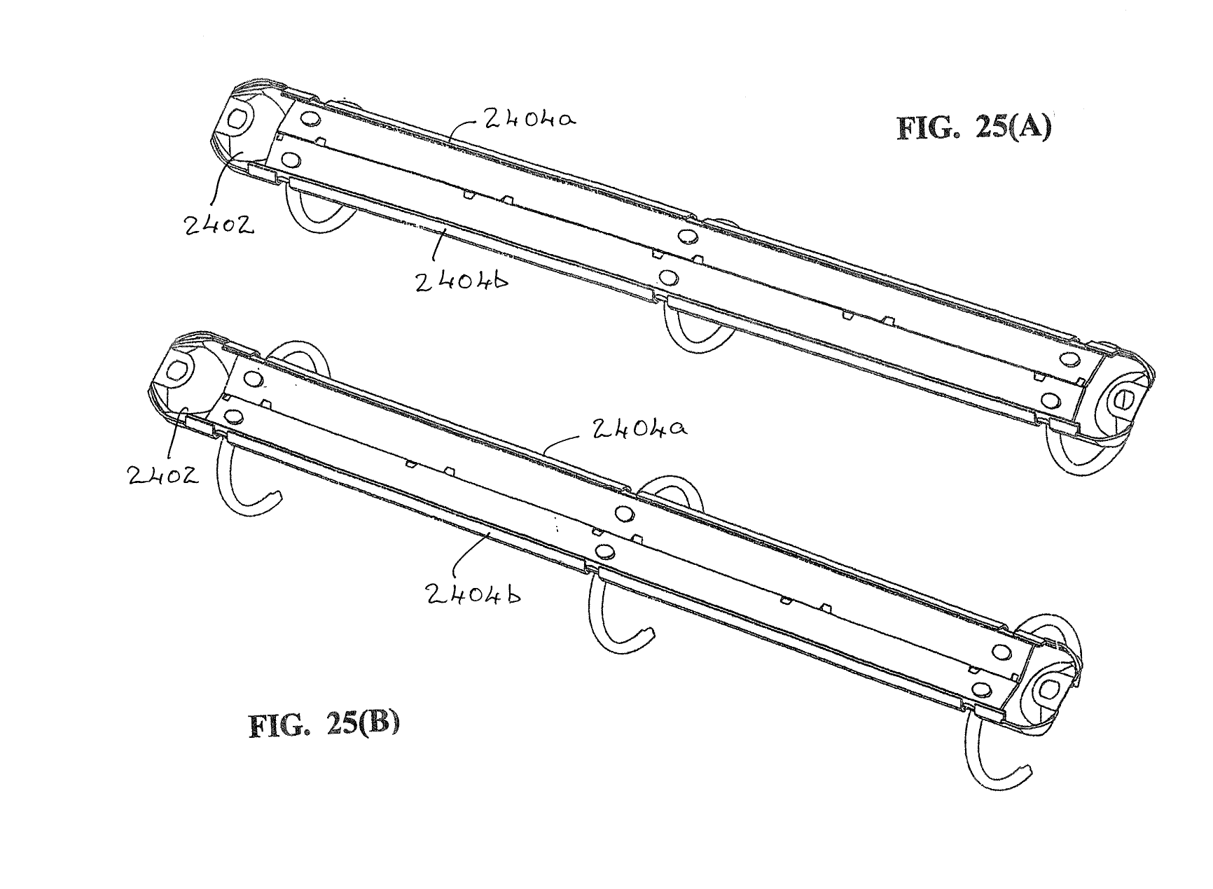

FIG. 23 in perspective view illustrates a fifth embodiment 2300 which is very similar to the fourth embodiment 1500. Thus, cover 2300 of this fifth embodiment functions like cover 1500 of the fourth embodiment but is shorter than cover 1500 in exactly the same manner as cover 200 was shorter than cover 500. Persons of ordinary skill in the art should be able to derive all necessary information concerning the fifth embodiment from the preceding descriptions.

Ring binders and documents generally stored therein are typically stored in storage rooms and the like where there may not be ample air circulation. Consequently, due to changes in ambient temperature and humidity, over time, the steel components of which many of the elements of the item-retaining housing are made may rust and/or corrode. Also, if the ring binder cover materials include fabrics, composites or leather, over time such materials may decompose or even otherwise may release gases or vapors that may have corrosive effects on adjacent metal parts. Such rust and/or corrosion, over time, can damage the items retained in the ring binders. The damage most probably will be worst close to the rusted or corroded components. Since element 108 is generally made of steel to have the desired inherent elastic deformability, the cover according to any of the embodiments disclosed herein may prove helpful in reducing such damage to items stored in the ring binders. In other words, if cover 200 or 800 is made of a material such as plastic or plastic covered fabric, and is adhered to element 108 by a moisture-resistant adherent, the edges of any papers or documents stored in the ring binder that are closest to element 108 will very likely suffer less damage from rust and/or corrosion of metal elements. Similarly, if the third fourth or fifth embodiment covers 1400, 1500 or 2300 are used, and the material of which any of them is formed is selected to be non-corrodible, then again any items such as papers stored in the ring binder will be less likely to be damaged by rust and/or corrosion of elements such as 108.

As a matter of convenience, in order to retrofit existing ring binders, it may be most convenient for most users to utilize either the first or second embodiments, i.e., cover 200 or 800. Similarly, for pragmatic reasons, covers such as 1400, 1500 or 2300 may prove most convenient in use if employed when the item-retaining housing components are assembled during manufacture of the ring binder. As noted earlier, by proper selection of the cover, a user can enjoy one or more of three benefits: first, the conveyance of useful information concerning items stored in the ring binder by visual or tactile information on the exposed surface of the cover; second, augmentation of the item-retaining capability of the ring binder by stiffening element 108 during use; and, third, significantly reducing damage to stored items from rusting and/or corrosion of metal elements contacting the same in the ring binder.

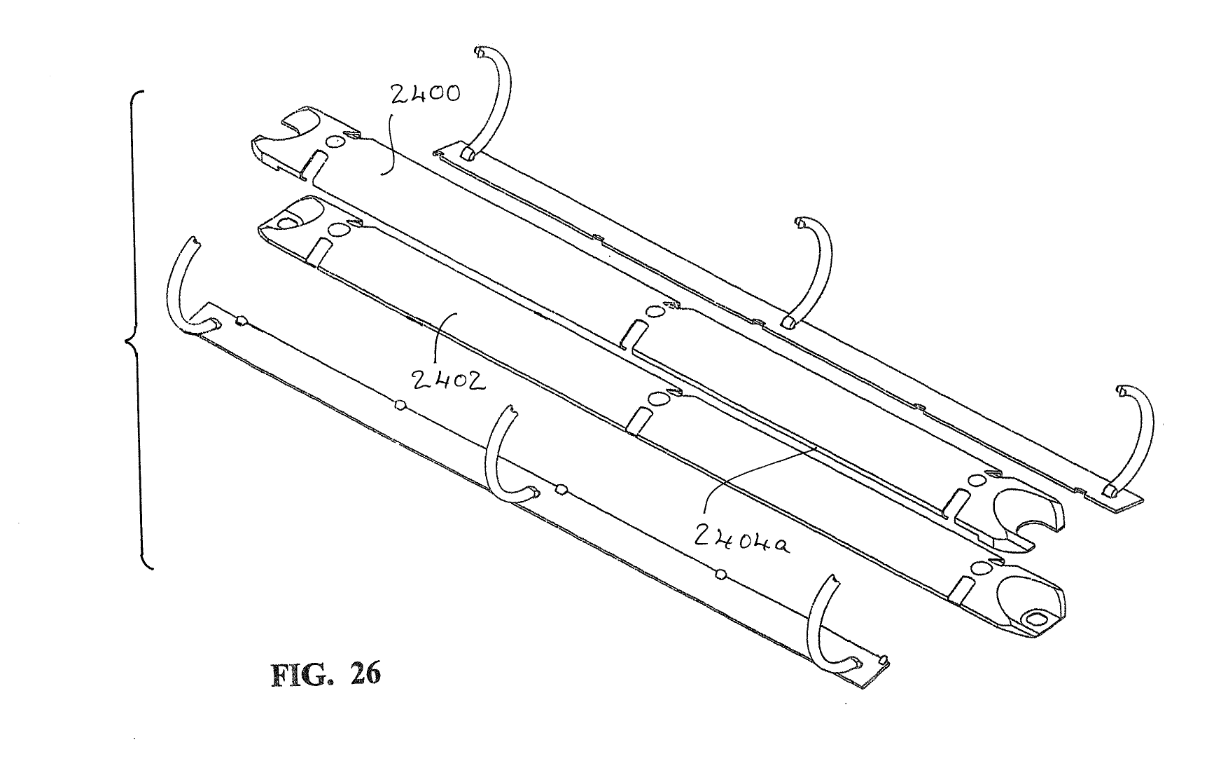

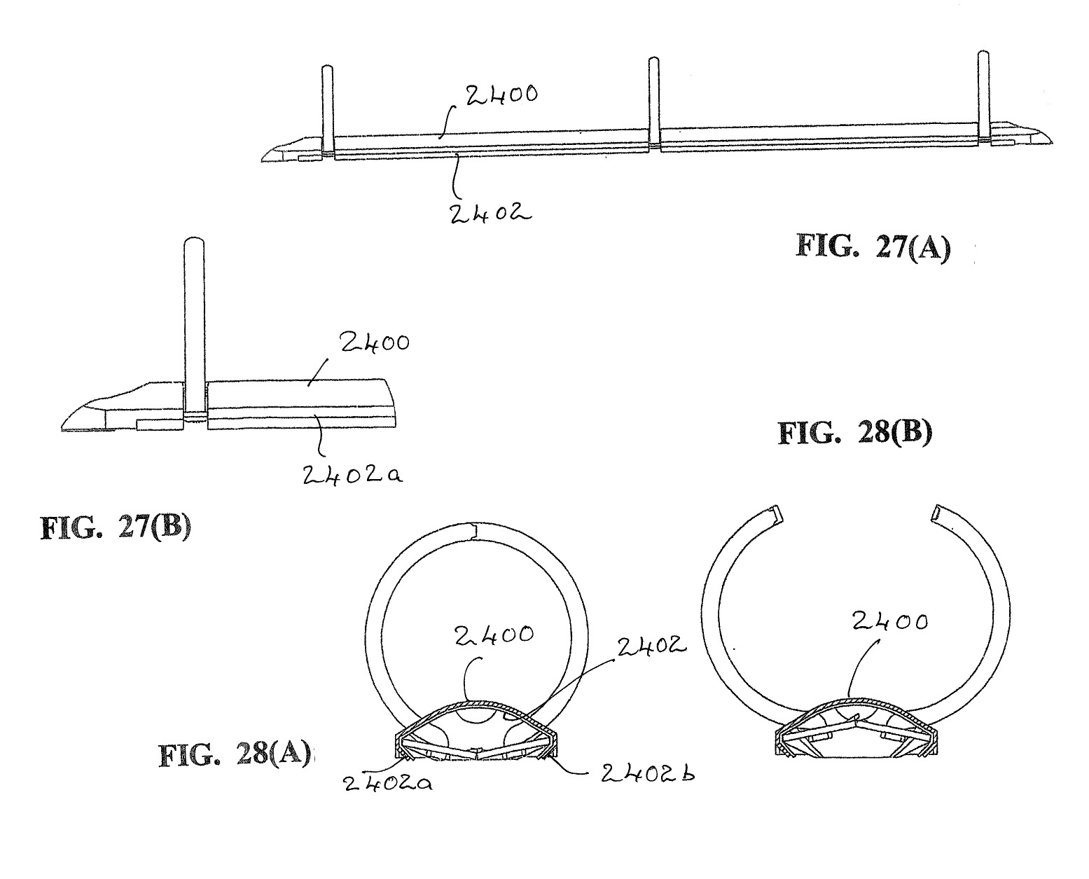

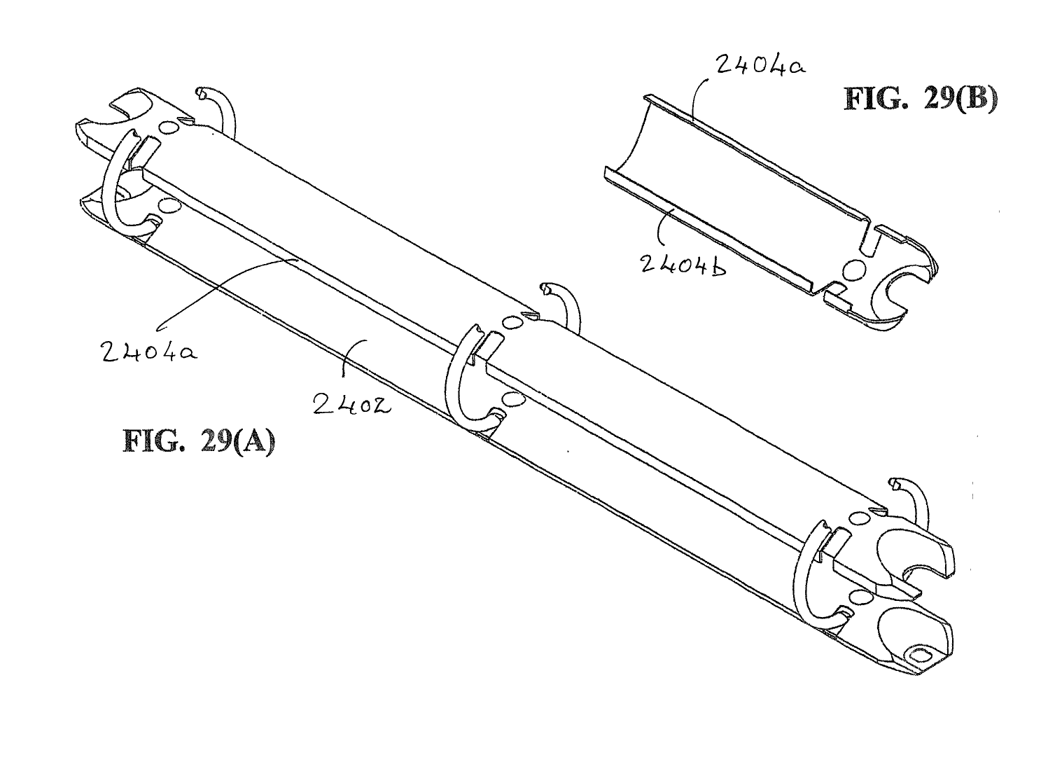

Cover 2400 according to the sixth embodiment is structured to fit to an item-retaining base that does not have the two movable end elements 122a, 122b as are provided in the first embodiment. It does, however, cover the entire base 2402, and grips the latter in snap-fit manner by its outer curved-in or bent-in sides 2404a, 2404b which are best seen in FIGS. 25(A), 25(B) and 26. This embodiment is one which covers the entire base 2402 and thus protects the latter against scratching damage over its otherwise exposed surface. It also protects sensitive users from making contact with the metal of the base 2402. This particular embodiment is preferably made of a stiff plastic or metallic material to also realize the corresponding benefit of providing additional bias to retain items as was discussed previously. The selection of the material, thickness, and the like are matters of engineering judgment by persons skilled in the mechanical arts.

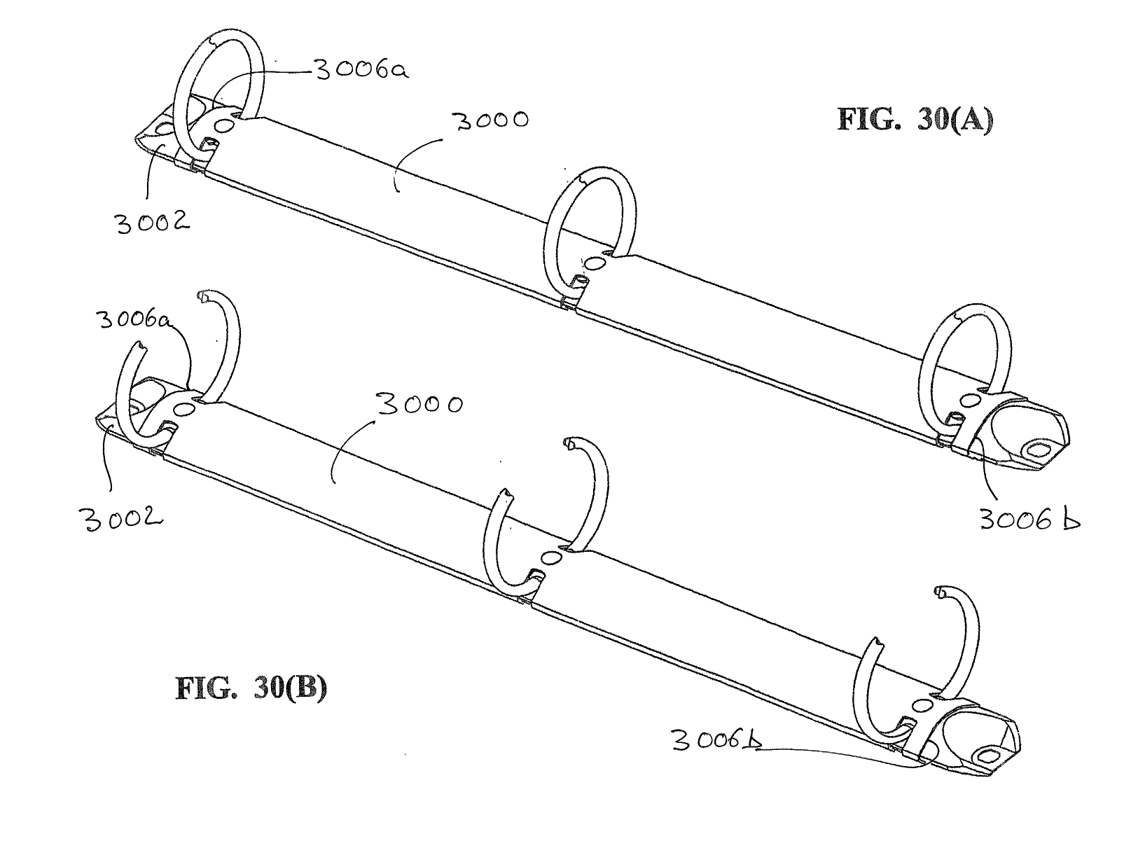

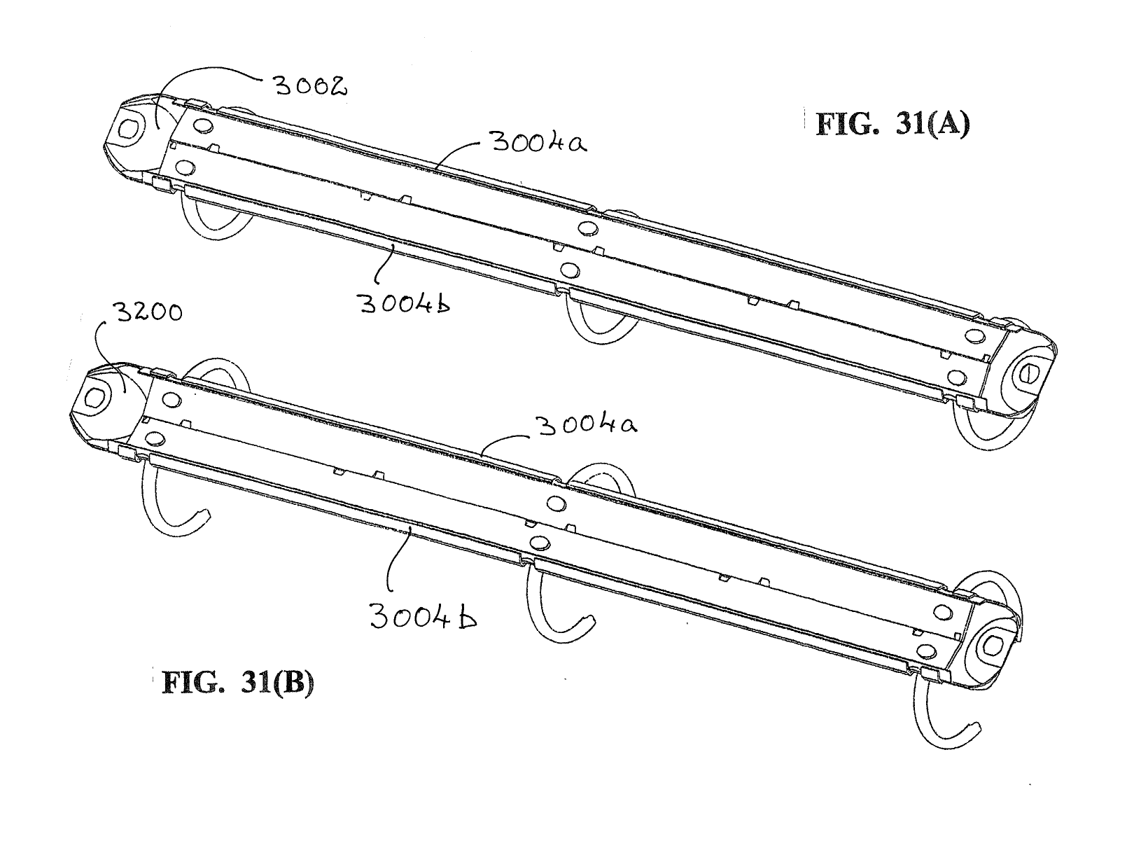

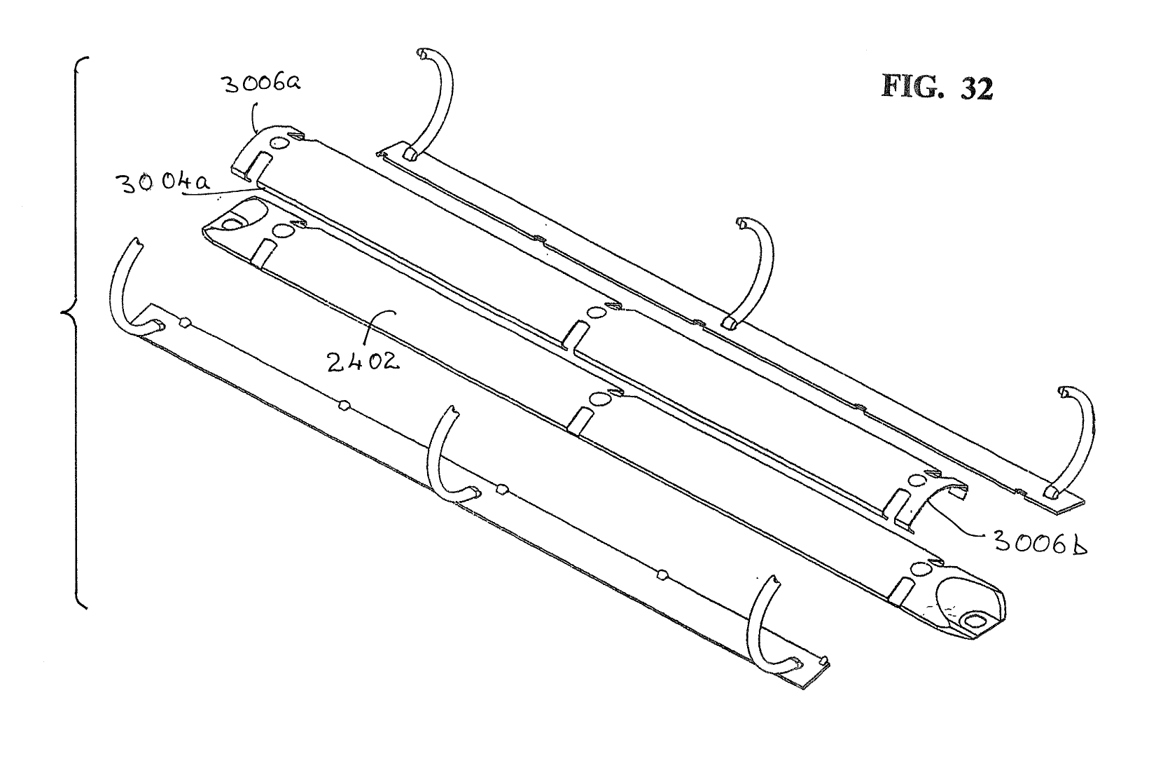

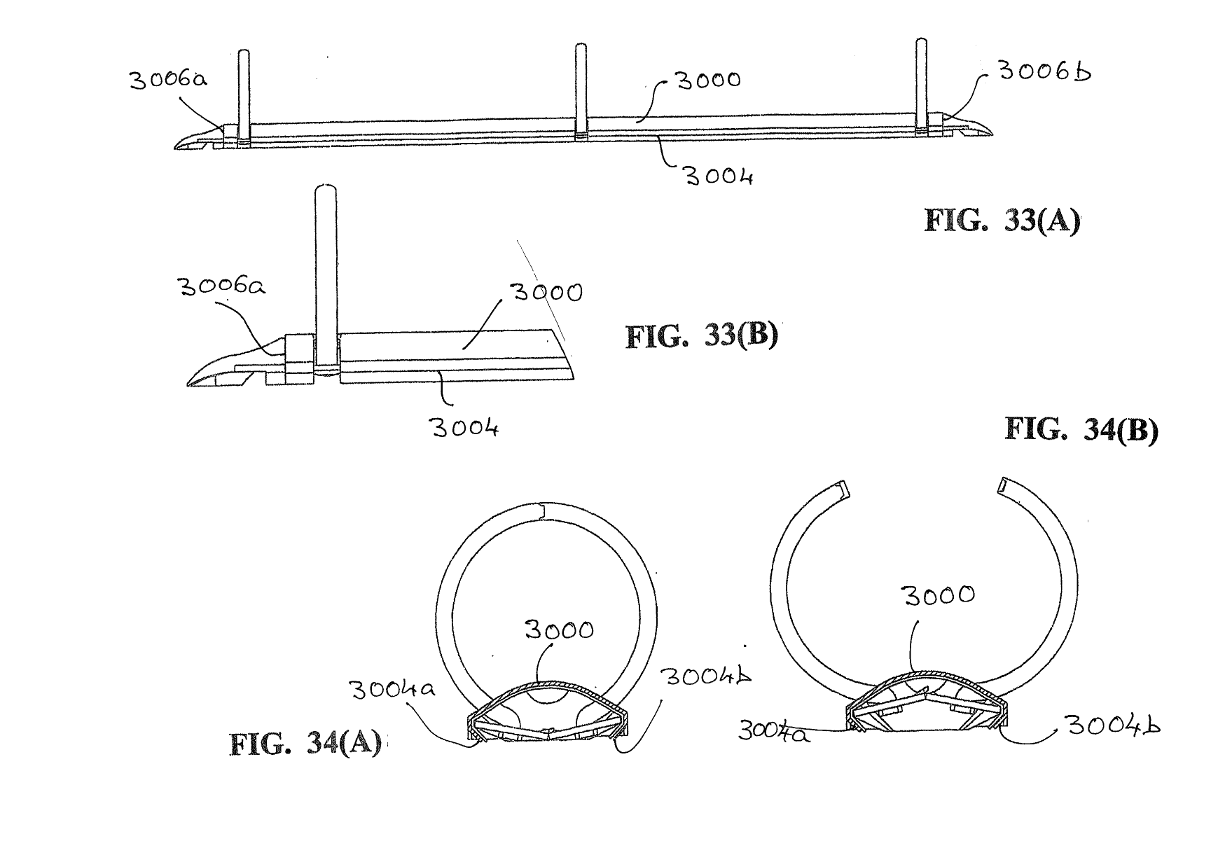

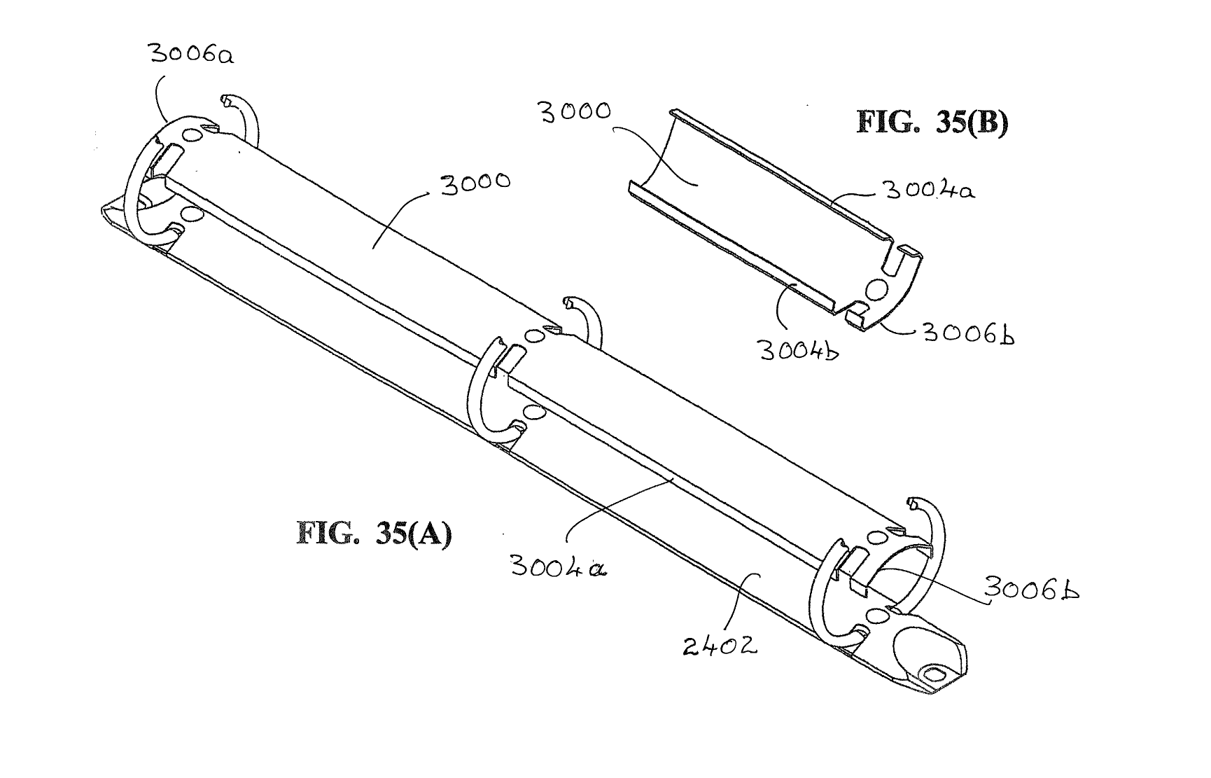

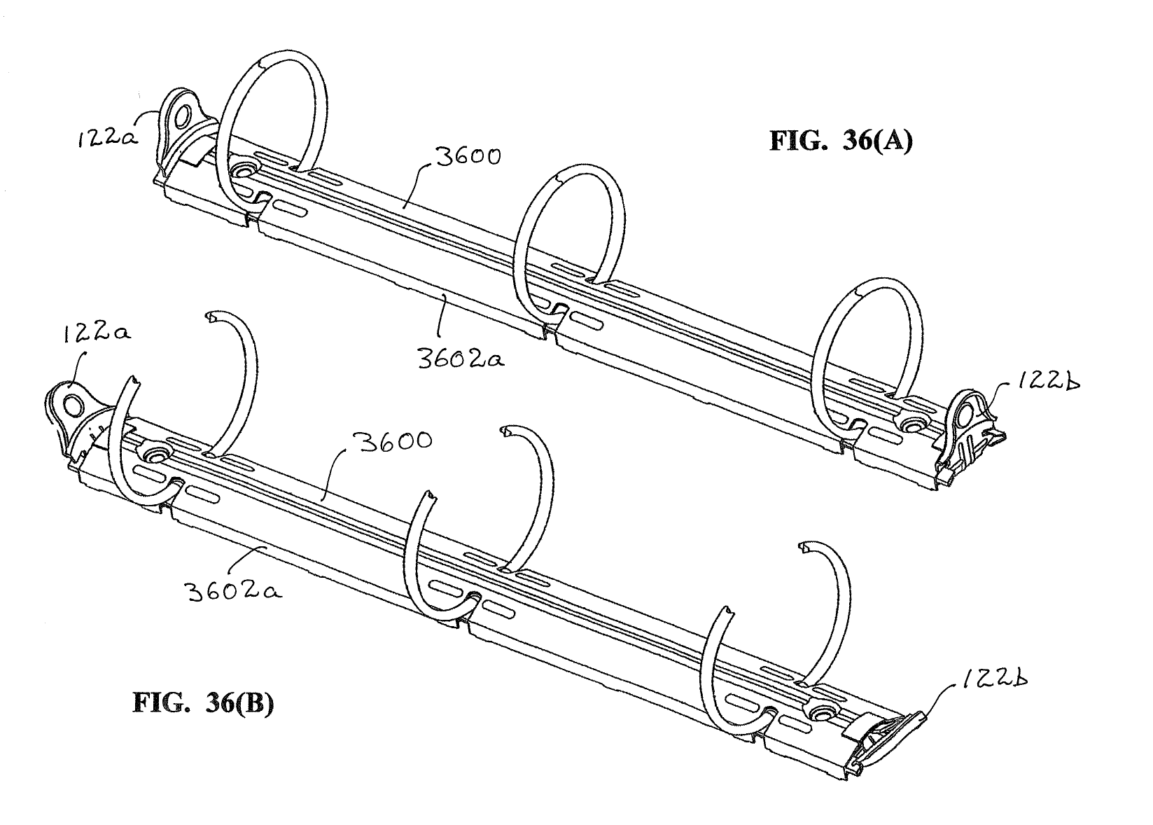

Cover 3000 according to the seventh embodiment, best seen in FIGS. 30(A) and 30(B), is a modified version of the sixth embodiment, being somewhat shorter longitudinally than cover 2400. It is otherwise similar to cover 2400, but does leave the extreme end portions of base 2402 exposed. This version may be easier for a user to put in place and remove or replace by introducing a nail at one of its ends, e.g., 3006a or 3006b.

As was noted earlier, and as is well understood by users of ring binders, it is sometimes very helpful to have the end levers to be able to operate the ring binder from its item-retaining state to its open state in which the split rings are snapped apart to permit removal or placement of items. As will also be readily understood by persons of ordinary skill in the mechanical arts, it is easier and less expensive to manufacture a device if one or more parts can be eliminated from the finished structure. Clearly, a ring binder without the movable end lever elements such as 122a, 122b should be less expensive to make and less expensive for the users to buy. All that such a user would need to do is to grab opposed split rings and force them apart to remove or place in any items.

It is a fact that some people are allergic to particular materials, e.g., constituents of perfumes, paints and the like. Less frequently, some are also allergic to skin contact with certain metals and alloys, e.g., to physical contact with elements made of or alloys of nickel. Many ring binder elements contain nickel, generally for durability and corrosion protection. Of the two versions of the sixth embodiment discussed above, such users might prefer the first kind i.e., 2400, which would cover the entire base 2402.

As also noted above, regardless of the material of any embodiment of the cover element selected, it will inherently provide the covered portion of the base at least some protection against scratching or denting over extended use. Obviously, metal should provide more such protection than, say, plastic or paper. But even a soft or compliant material will provide some such protection. Furthermore, if an adhesive material is employed to affix the cover element to the underlying base that in itself may provide protection against moisture-induced corrosion of the base metal. The interpositioning of a nonallergenic material of any kind between nickel and the user's skin may also be a realized benefit in all of the different variations of this invention.

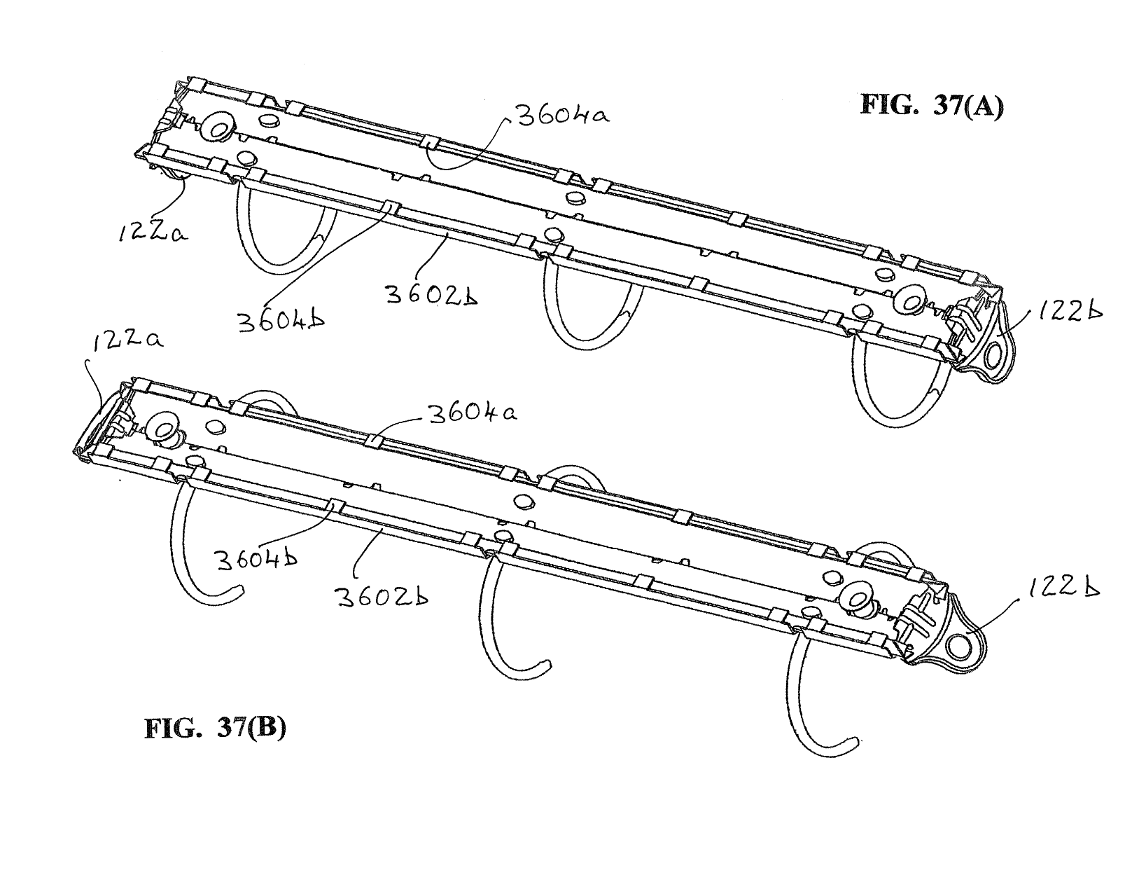

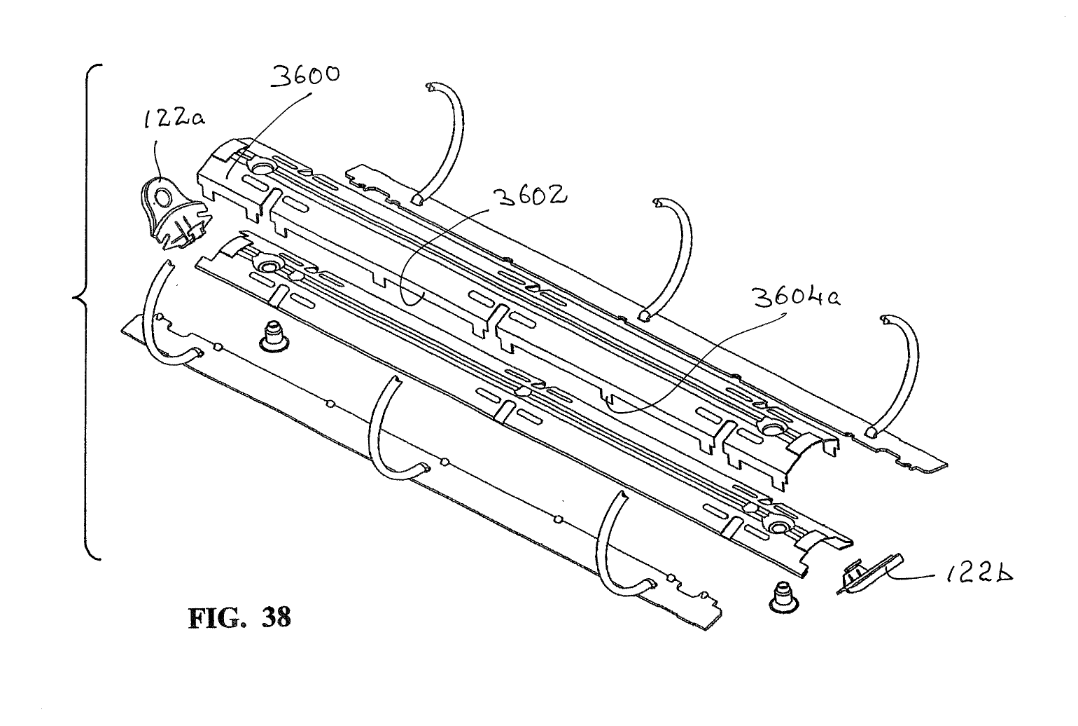

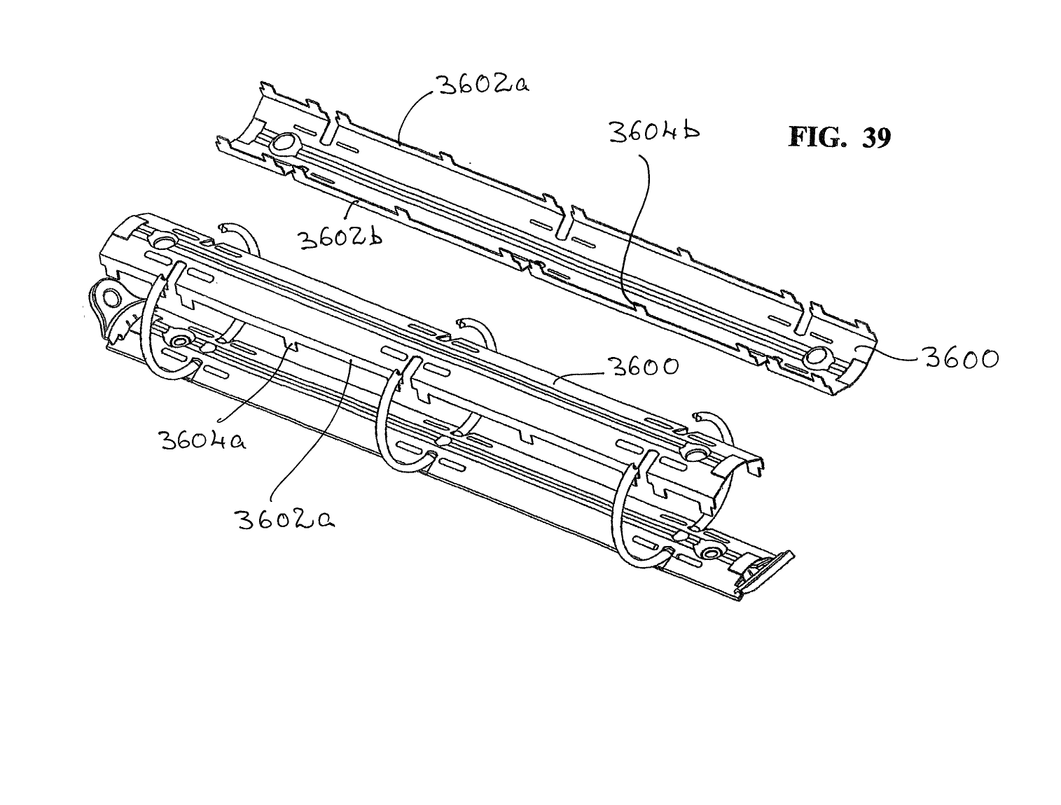

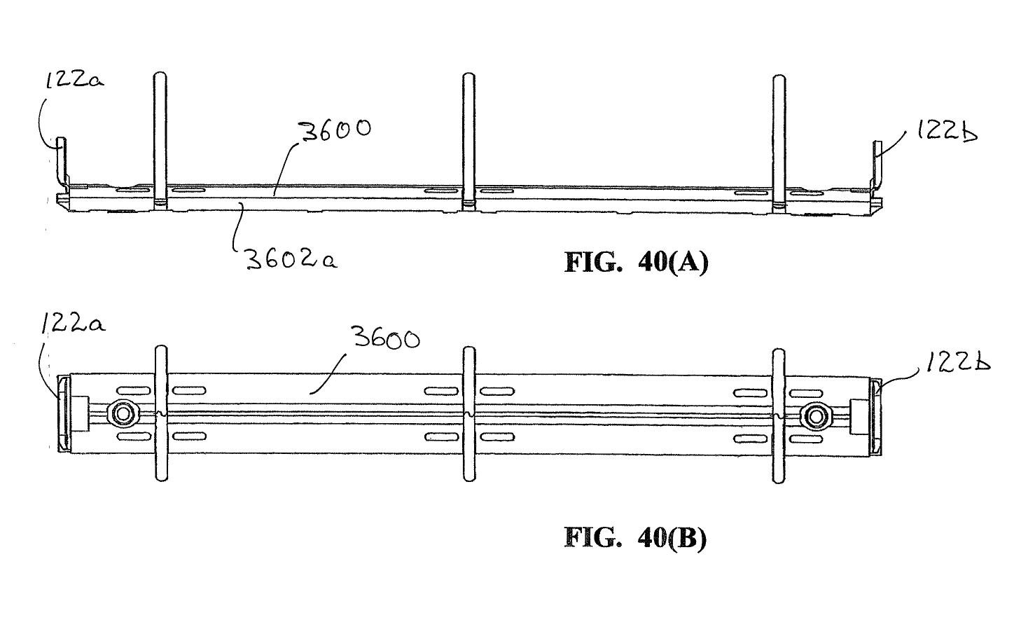

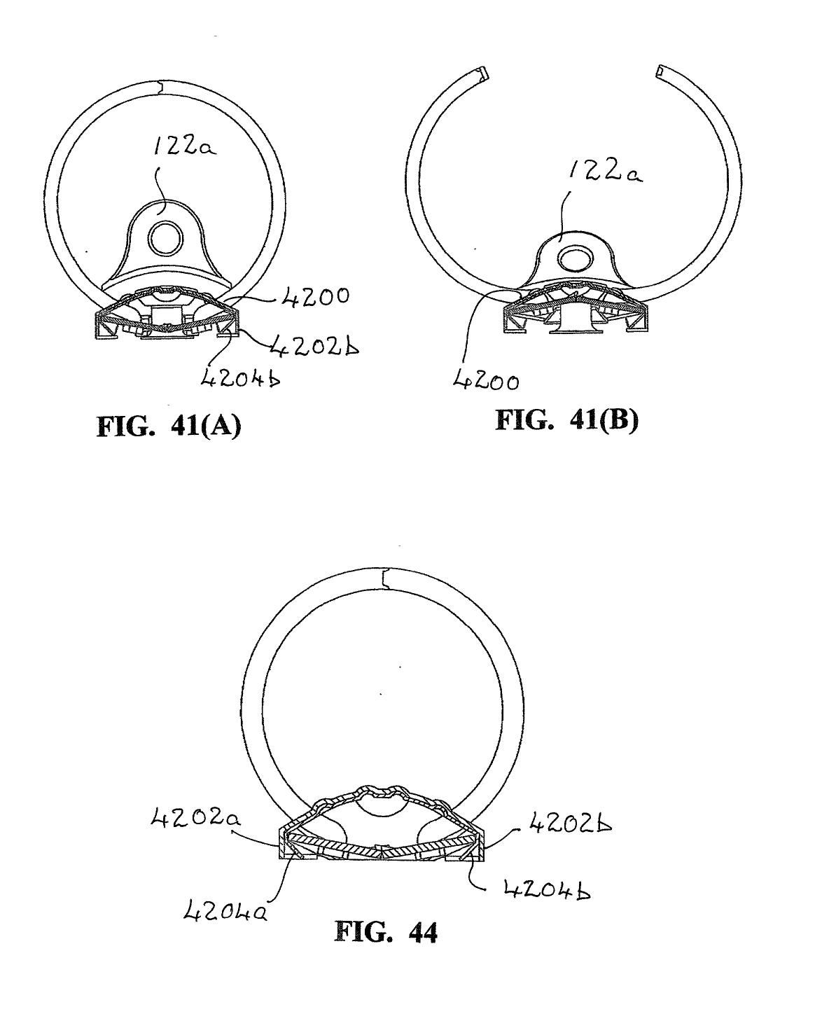

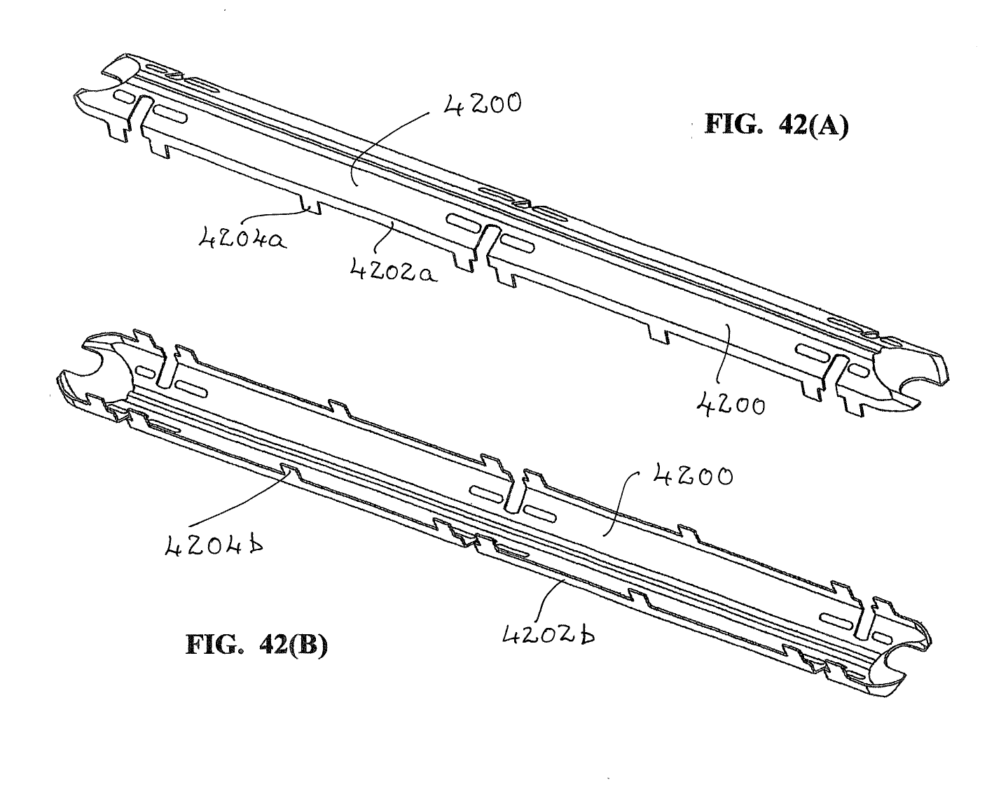

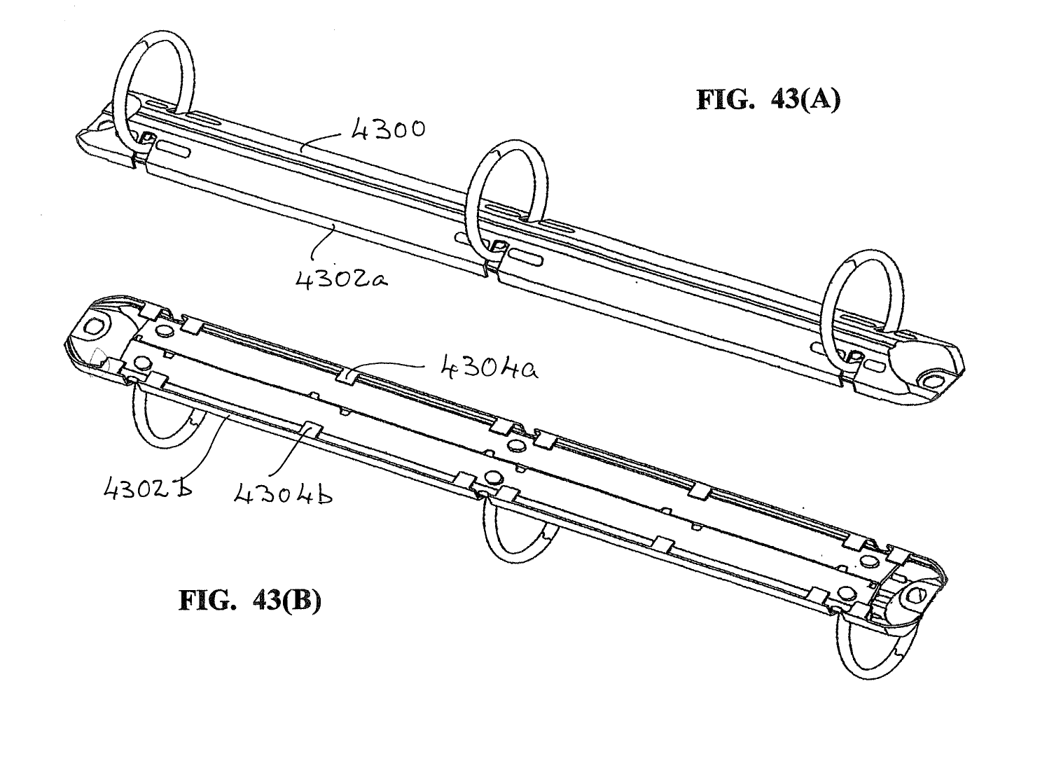

The eigth embodiment 3600, per FIGS. 36(A) through 41(B), is yet another variation of this invention—one particularly suitable for being made of a heat deformable plastic or metal. This version is suitable for use with ring binders with movable end levers that enable easy operation of the item-retaining elements as described earlier. FIGS. 42(A) and 42(B) show a modification thereof that is adapted for use in a ring binder that lacks the movable end levers such as 122a, 122b. The main distinction of this embodiment is the provision of a cover body 3600 that has elongate sides 3602a, 3602b which each in turn have deformable tabs 3604a, 3604b which are deliberately bent inwards to grip the corresponding elongate sides of the base of the ring binder mechanism. The version 4202 has sides 4202a, 4202b with respective pluralities of tabs 4204a, 4204b, as best seen in FIGS. 42(A) and 42(B). FIGS. 43(A) and 43(B) show how, in a version 4300 suitable for use with a ring binder free of the movable end levers, these tabs 4304a, 4304b are folded over or bent inwards over the sides of the underlying base to grip the same. Plastics materials are known that will readily soften a little to permit easy bending and will then harden and toughen up when cooled in the bent position.

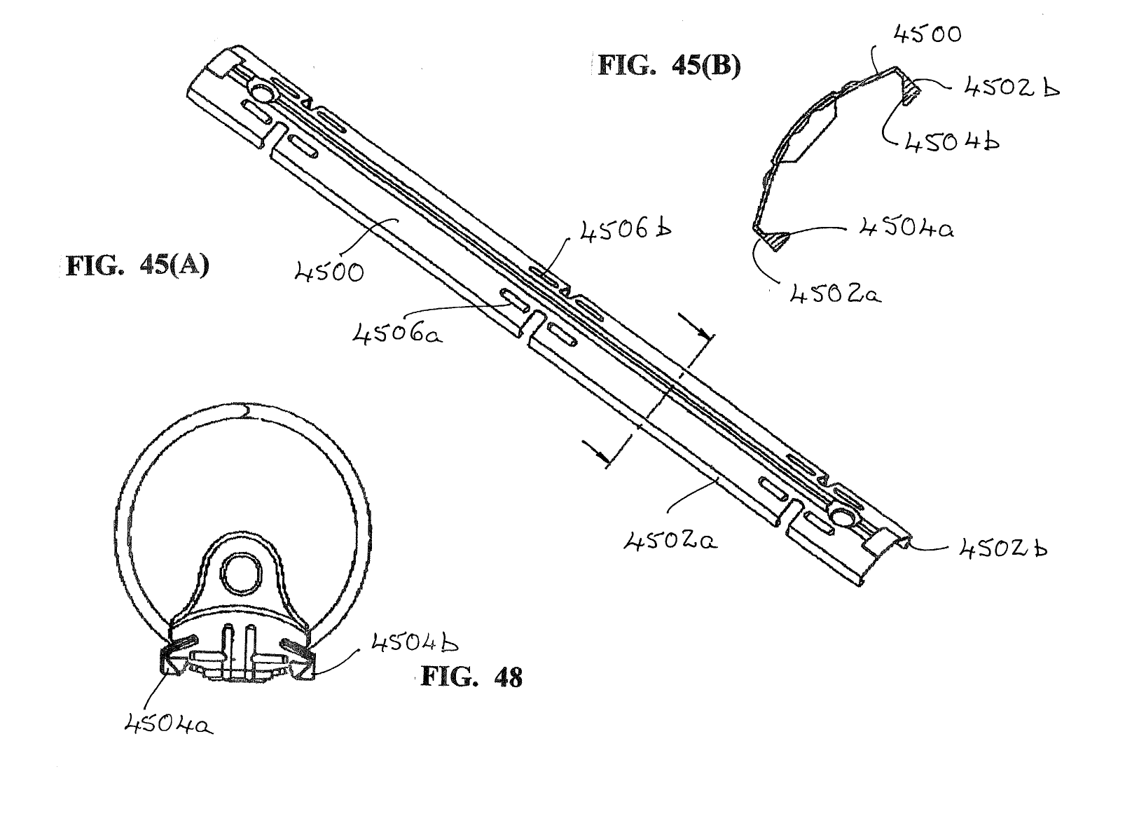

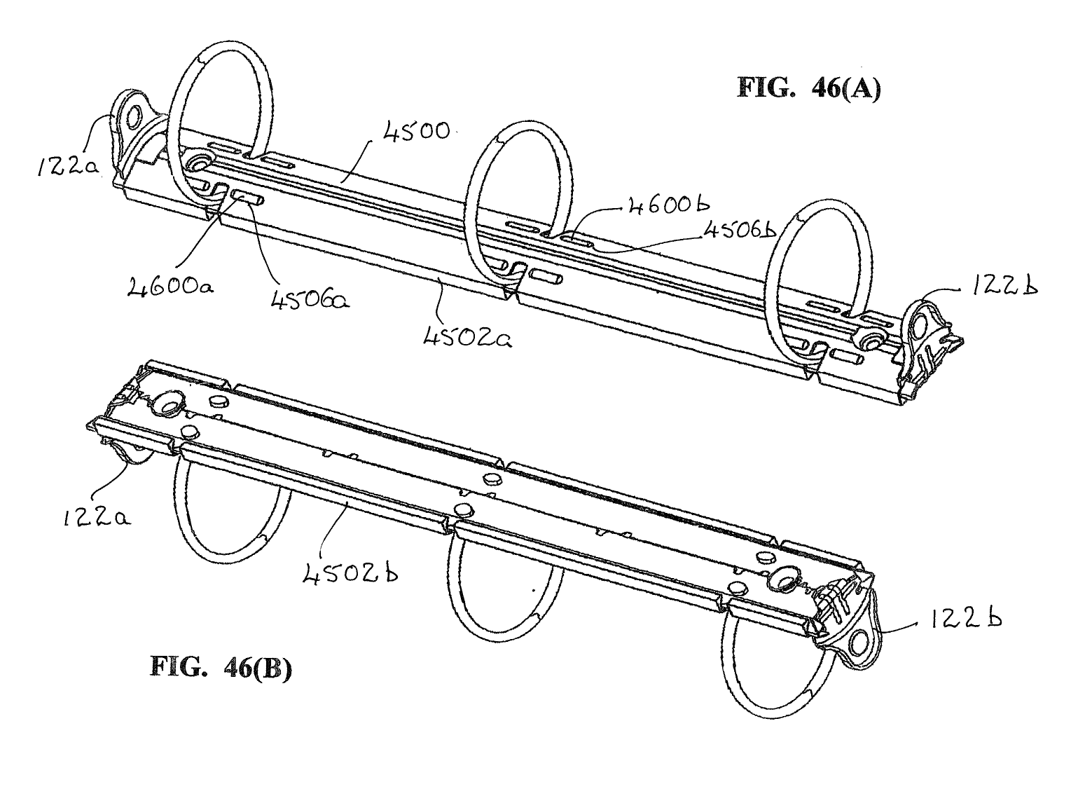

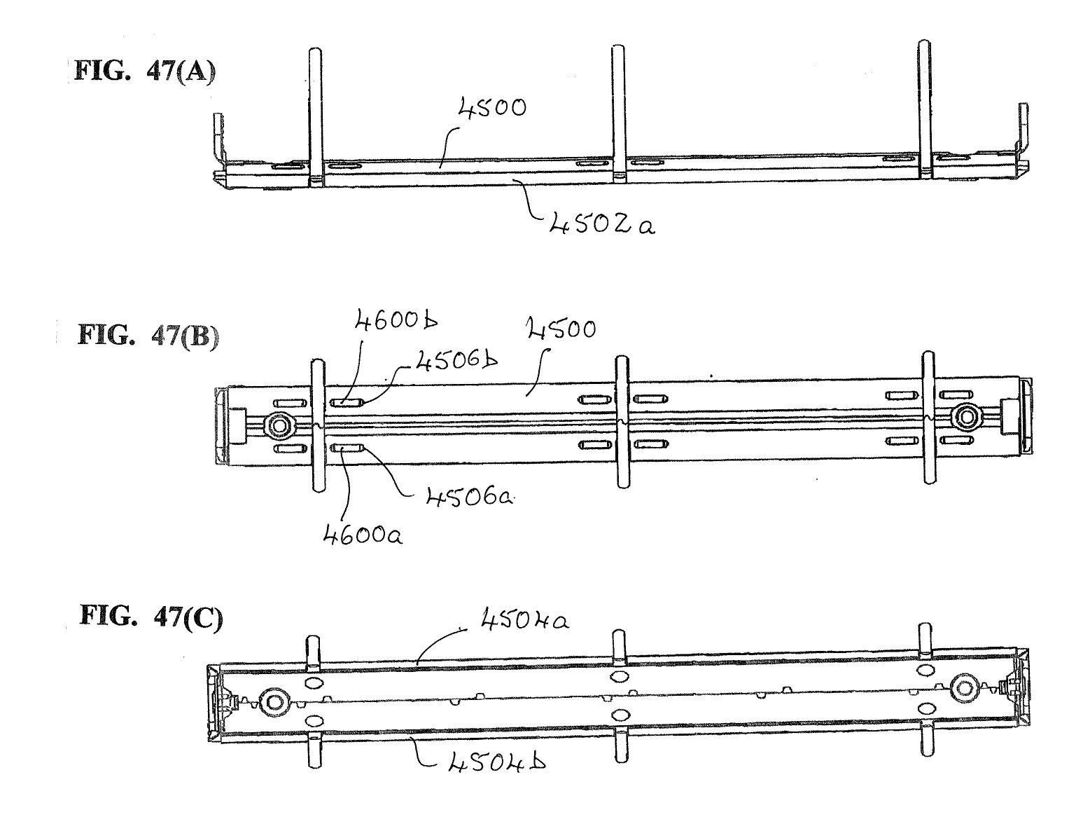

Finally, FIGS. 45(A) through 48 show another embodiment, one in which the cover 4500 has opposite sides 4502a, 4502b which have generally triangular cross-sections 4504a, 4504b that serve to make these sides stronger and, simultaneously, improve their grip on the underlying base. This is best understood with reference to FIG. 48. Note that cover 4500 may also be provided with elongate apertures 4506a, 4506b which are sized and distributed to snap-fit to correspondingly sized and distributed protrusions 4600a, 4600b provided on the underlying base element of the ring binder. Incidentally, forming the base to have such protrusions will tend to make it stiffer, thus enhancing the bias force it will exert on the split ring elements to retain items in place. A similar affixation method may be used with the embodiment per FIGS. 36(A) and 36(B) in the same manner.

Persons of ordinary skill in the art are expected to consider other obvious variations of the invention as disclosed herein. For example, some ring binders are formed with only two pairs of split rings, generally positioned along the top edges of documents. The present invention can be readily adapted for such an application. Alternatively, e.g., to retain large or oddly shaped items, more than three ring sets may be employed and the disclosed covers adapted to suit. As repeatedly indicated above, there is a myriad of ways to affix the cover in its working disposition on the underlying base portion of a ring binder. Such ways include, but are not limited to, adhesion, snap-fitting, riveting by hollow sleeves or conventional rivets, and the like. The affixation may be permanent and established at the time of manufacture of the ring binder, or it may an option available to a user as an after-market element applied temporarily or left in place permanently.

Accordingly, it is considered that all such obvious modifications and variations are comprehended within the scope of the disclosed invention as claimed hereinbelow.

What is claimed is:

1. An information-conveying cover for a longitudinal housing that includes retaining elements for retaining items in a ring binder, comprising:
an elongate body portion, formed to fit to and cover a selected portion of the housing; and
a retaining mechanism for retaining the elongate body portion to the housing, with a first surface of the elongate body portion perceptible by a user independently of any items retained by the housing at least when the ring binder is open.

2. The cover according to claim 1, wherein:
the retaining mechanism comprises elastically deformable side elements respectively provided on opposite sides of the elongate body portion to fit to and be retained to corresponding sides of the housing.

3. The cover according to claim 1, wherein:
the retaining mechanism comprises an adherent material disposed to adhere a second surface of the cover to an adjacent portion of the housing.

4. The cover according to claim 3, wherein:
the adherent is applied to the second surface of the cover and is initially covered by a protective element removable to enable adherence of uncovered adherent to the housing.

5. The cover according to claim 1, wherein:
at least the first surface comprises a portion specifically formed to convey selected information, by at least one of sight and touch, to a user.

6. The cover according to claim 1, wherein:
the cover comprises a material selected from a group of materials consisting of metal, rubber, plastics, paper, fabrics and composites.

7. The cover according to claim 1, wherein:
the cover has a predetermined stiffness and is initially fitted to the housing so as to resist subsequent deformation of the housing to a degree related to said predetermined stiffness, to thereby correspondingly modify a force required to be exerted by a user to operate the housing to add to or remove any items from the ring binder.

8. The cover according to claim 7, wherein:
the retaining mechanism comprises at least one fastening element to securely fasten the cover to the housing.

9. The cover according to claim 8, wherein:
the at least one fastening element comprises a pair of elongate outer side portions of the cover that are formed to fit forcibly to corresponding elongate outer side portions of the housing.

10. The cover according to claim 8, wherein:
the at least one fastening element comprises a snap-fit mechanism extendable through a corresponding location in the covered portion of the housing.

11. The cover according to claim 10, wherein:
the snap-fit mechanism comprises a plurality of cooperating elastically deformable extensions integral with the cover.

12. A method of enabling a user to readily ascertain a selected aspect of items retained by retainer elements of a ring binder housing in a ring binder, comprising the steps of:
attaching to the ring binder housing a cover element having a first surface perceptible by a user independently of any items retained in the ring binder; and
providing information at the first surface, relating to the selected aspect of the items, whereby the user can perceive the information and thereby ascertain the selected aspect without having to examine the items.

13. The method according to claim 12, wherein:
the information is visually perceptible.

14. The method according to claim 12, wherein:
the information is perceptible by touch.

15. The method according to claim 12, comprising the further step of:
selecting the cover to be of a predetermined stiffness, shape and size to closely fit to the ring binder housing to thereby correspondingly affect a force required to be exerted to operate the ring binder to add to or remove items therefrom.

16. The method according to claim 12, wherein:
the attaching is obtained by adhering the cover to the ring binder housing.

17. The method according to claim 12, wherein:
the attaching is obtained by snap-fitting the cover to the ring binder housing.

18. The method according to claim 12, wherein:
the step of attaching the cover element to the ring binder housing comprises the steps of temporarily deforming a portion of the cover elastically to engage a corresponding portion of the ring binder housing and then releasing the cover element to thereafter tightly fit the cover element at least to outer edge portions of the ring binder housing.

19. An improved ring binder for retaining items, comprising:
an outer binder body;
an item-holder body attached to the binder body, comprising at least one pair of cooperating forcibly biased item-retaining elements locatable in either an item-retaining or an item-releasing position; and
a cover attachable to the item holder body and bearing information related to items to be retained in the ring binder, the information being of a kind perceivable at a first side of the cover independently of any item retained in the ring binder.

20. The ring binder according to claim 19, wherein:
the information is visually perceptible.

21. The ring binder according to claim 19, wherein:
the information is perceptible by touch.

22. The ring binder according to claim 19, wherein:
an adherent material is disposed to adhere a second side of the cover to the item-holder body.

23. The ring binder according to claim 19, wherein:
the cover has an elongate body portion of predetermined stiffness and is formed to fit to and cover a selected portion of the item-holder body, and is fitted to the item holder body so as to resist deformation of the item-holder body to a degree related to the stiffness of the cover to thereby correspondingly modify a force required to be exerted to operate the ring binder to add to or to remove items from the ring binder.

24. The ring binder according to claim 19, wherein:
the information is perceptible by at least one of sight and touch.

25. The ring binder according to claim 23, wherein:
the item-holder body has first outer elongate edge portions, and
the cover has corresponding second outer elongate portions that are shaped and disposed to elastically fit tightly to the first outer elongate edge positions to thereby apply a bias force tending to resist deformation of the item-holder body during operation of the at least one pair of item-retaining elements.

26. The ring binder according to claim 25, wherein:
the second outer elongate portions of the cover have respective re-entrant edge portions to enable retention of the cover to the item-holder body.

27. The ring binder according to claim 25, wherein:
the cover is retained to the item-holder body solely by an elastic fit thereto.

28. The ring binder according to claim 25, wherein:
the item-holder body is formed to have at least one through aperture, and
the cover is formed to have at least one extension shaped and located to snap-fit into said at least one aperture to thereby securely retain the cover to the item-holder body.

29. The ring binder according to claim 25, wherein:
the item-holder body is formed to have a first plurality of apertures,
the cover is formed to have a corresponding second plurality of apertures, and
the ring binder further comprises a corresponding third plurality of deformable elements that each extend through one of the first plurality of apertures and a corresponding one of the second of apertures and are thereafter deformed to hold the cover to the item-holder body.

30. The ring binder according to claim 25, wherein:
the item-holder body is formed to have a plurality of apertures in a selected disposition, and
the cover is formed to have a plurality of elastically deformable cantilevered extensions on a second side, the extensions being provided in cooperating sets so that each set of extensions can snap-fit into a corresponding one of the apertures in the item-holder body to thereby engage the cover to the item-retaining body.
